(19) United States
(12) Patent Application Publication
(10) Pub. No.: US 2005/0003324 A1
(43) Pub. Date: Jan. 6, 2005

(54) Orthodontic bracket positioning device and method

(76) Inventor: Brian C. Reising, Atlanta, GA (US)

Correspondence Address: GARDNER GROFF, P.C.;PAPER MILL VILLAGE, BUILDING 23, 600 VILLAGE TRACE, SUITE 300, MARIETTA, GA, 30067, US

(21) Appl. No.: 10/750,194

(22) Filed: Dec. 31, 2003

Related U.S. Application Data
(60) Provisional application No. 60/437,546, filed on Dec. 31, 2002.

(51) Int. Cl. A61C 3/00

(52) U.S. Cl. 433/50; 433/53

(57) ABSTRACT

A device for positioning orthodontic brackets on lingual and/or facial surfaces of mal-occluded teeth. The positioning device has a base and a superstructure with an adjustable platform for mounting a model of a patient's teeth and a free-floating composite register assembly. The composite register assembly includes a vertical register assembly, a torque register assembly, a rotation register assembly, and a bracket holder assembly, which are all adjustable for precise positioning of the brackets on the teeth. A method of positioning orthodontic brackets on lingual and/or facial surfaces of teeth includes registering the existing position of the mal-occluded teeth and positioning the brackets so that after the orthodontic treatment is complete the brackets are aligned in an ideal arch.

### CROSS-REFERENCE TO RELATED APPLICATION

This application claims the priority benefit of U.S. Provisional Patent Application Ser. No. 60/437,546, filed Dec. 31, 2002, the entire scope and content of which is hereby incorporated herein by reference.

### TECHNICAL FIELD

The present invention relates generally to dentistry and orthodontics and, in particular, to attaching orthodontic brackets to teeth for repositioning the teeth.

### BACKGROUND OF THE INVENTION

Orthodontists commonly correct the position of mal-occluded and mal-aligned teeth by therapeutic tooth movement. Therapeutic tooth movement is accomplished by the application of force to teeth to reposition them. Many orthodontic appliances have been used to apply force to teeth. The most commonly used orthodontic appliance for tooth movement is commonly known as the “edgewise appliance” or more specifically the “fixed pre-adjusted edgewise appliance” —also known as the “straight-wire appliance.” The name “edgewise” refers to the general mechanism of a rectangular slot engaged by a force-generating rectangular wire. The terms “straight-wire”, “pre-adjusted”, and “pre-programmed” refer to an elective, though highly desirable, feature of an edgewise appliance system that will be described as follows.

An edgewise appliance system is a combination of many individual pieces designed to function in a coordinated fashion. The two primary components are tooth “attachments” that are attached to the teeth and “arch-wires” that engage the attachments. The attachments (brackets or bands) are semi-permanently and rigidly attached to the teeth. Typically, the attachments are fabricated of stainless steel, porcelain (ceramic), plastic, or combinations of these materials. The attachments serve as a standardized “handle” by which the tooth may be engaged by a force.

Each attachment in a system (generally referred to as a “bracket”) possesses a rectangular slot that receives the arch-wire component. Typically, all the attachments of a particular system will have the same rectangular slot dimensions of about 0.018×0.025 inches, 0.020×0.025 inches or 0.022×0.025inches. Some operators prefer to use a combination of various size slots. The slot shape is rectangular to accommodate a wire with a rectangular or square cross section, which permits application of forces and hence control of tooth position in three dimensions.

Typically, arch-wires are made of metal alloys capable of varying degrees of elastic deflections depending on their size, cross-sectional shape, and composition. The elastic deflections in the arch-wire generate forces on the brackets, which in turn translate the forces to the teeth, thereby causing the teeth to move to a desired position.

The human teeth are arranged spatially in the upper or lower jaw (the maxillary or mandibular dental arches respectively) in the shape of an arch with their long axes generally perpendicular to the plane of the arch. The precise shape of the arch varies among individuals from more U-shaped arches to V-shaped arches to parabolic arch forms. The precise shape of any particular arch can vary substantially.

Given that the teeth are naturally arranged in this relatively flat-plane arch-form, it is commonly recognized as an objective of orthodontic therapy that this plane should be made relatively flat and that the teeth should be aligned precisely to form an arch-form shape that is similar (but improved) to the pre-existing condition of the dentition. To serve this objective, the “straight-wire”, “pre-adjusted”, or “pre-programmed” concept of appliance design was derived as a means of executing orthodontic therapy with greater ease, efficiency, and quality. The basic concept of “straight-wire” is that, if the objective of orthodontic therapy is to position teeth in a flat plane, then the force generated by elastic deformations in a flat, straight wire shaped in the form of an arch is an ideal mechanism for producing those results. In theory, the attachments are rigidly fixed to teeth at a precise “pre-adjusted” or “pre-programmed” position on the mid-facial or lingual aspect of a tooth at their respective mal-aligned state. A straight (flat) arch-shaped wire is then deflected to engage the mal-aligned attachments slots. The force generated by the elastic deformation of the wire then “pulls” the teeth along with it as it moves back towards its original shape. The attachment position on each tooth then determines the ultimate and final relative position of each tooth relative to the other teeth upon achievement of the “straight-wire” condition (the theoretical end-point).

Traditionally, the vast majority of orthodontic therapy has been performed with attachment slots placed primarily on the facial aspect of the teeth. It can be readily deduced via casual observation of an arch of teeth that the mid-facial aspects of an arch of teeth tend to align in a straight, flat arch form. However, it is also readily observed upon closer inspection that these mid-facial surfaces do not exactly line up in a straight line with their long axes residing at identical orientations. In fact, one can readily observed consistent deviations in the spatial relations of an arch of tooth crowns and roots. Each tooth type tends to deviate in a specific consistent “average” way relative to the horizontal plane. As such, early pioneers of appliance design theorized that compensations in bracket slot orientation relative to the bracket base could automatically compensate for these differences.

They also realized that the anatomy among types of teeth (upper right central incisor, versus, for instance, an upper right canine, etc.) varies substantially. But because this anatomy is consistent among different individuals for each tooth type, each tooth type, therefore, could receive its own uniquely shaped “average” bracket slot and base orientation. This pre-defined shape can theoretically be used on a particular tooth type for any particular individual. Thus, while the general shape of a bracket system might be very similar, for each particular tooth type the corresponding bracket is designed with specific compensations in base shape, base size, general shape, slot angulation, base thickness, etc. to accommodate differences in tooth type anatomy and tooth type spatial relations relative to the horizontal plane.

The intention of these design specifications was to create a universally applicable appliance that will, if brackets positions are accurately coordinated, create an ideal alignment of teeth if a straight wire is deflected into each slot and if the wire is subsequently permitted to express its original straight shape. By doing so, the operator would possess a pre-programmed mechanical system. Having realized a truly pre-programmed system, theoretically, the operator could eliminate the need for manual manipulation of the system (via the placement of compensating bends in the arch-wire component) and thus produce a highly predictable and efficient outcome.

However, as mentioned, the efficient utilization of a so-called straight-wire appliance depends largely on the orthodontist's ability to coordinate the position of the brackets on mal-aligned teeth so that the forces imposed by deflections of the resilient, straight, arch-wire will result in perfect three-dimensional alignment of the teeth. If the brackets are not properly positioned, then the degree of mal-positioning will be reflected as a proportional degree of mal-positioning of the teeth. Correcting these mal-positions would then require the operator to manually manipulate the shape of the arch-wire component via the placement of compensating arch-wire bends. This is recognized as a comparatively laborious, slow, unpredictable, and inefficient method.

Most orthodontists position the brackets on the patient's teeth using a “direct” method. “Direct” refers to the positioning of each bracket on each tooth directly, inside the patient's mouth. But when working directly inside the mouth it is very difficult to visualize precise bracket positioning and extremely cumbersome to utilize measuring instruments for determining vertical position. Because accurate positioning is so difficult, getting the bracket “close enough” is widely regarded as an acceptable compromise. Because precise positioning of an entire arch of brackets is the exception rather than the norm, the result is a huge compromise in treatment quality and efficiency.

To improve the accuracy of bracket positioning in a typical private practice setting, “indirect” positioning methods have been developed. Rather than positioning brackets directly inside the patient's mouth, the brackets are positioned on a three-dimensional model of the patient's teeth, outside the patient's mouth. In this way, improved visualization and the utilization of measuring devices are permitted, so accurate positioning becomes much more simple and attainable. Once the brackets are positioned on the model and rigidly attached, a “transfer tray” is fabricated and utilized to transfer the brackets from the model to the patient's mouth. The tray preserves the brackets position during the transfer. There are a number of known variations of indirect methods, including those described in U.S. Pat. No. 5,971,754 to Sondhi et al. and U.S. Pat. No. 4,952,142 to Nicholson, which are hereby incorporated herein by reference.

Generally, with a facial or lingual bracket system, it is also common to use a tube attachment on molar teeth, rather than an open-face-slot bracket design. The tube type of attachment receives the arch-wire component via threading of the wire through the mesial or distal ends of the tube. This type of attachment has the benefit of not requiring the protruding, bulky, irregularly shaped tie-wings that are required of an open-face design. However, their applications are limited to the posterior teeth due to the necessity of threading the wire through the mesial or distal ends. It would be an impractical endeavor to attempt threading an arch shaped wire through an entire dental arch starting from the most distal molar. Not only would the wire initial need to extend into the patients throat but the lack of a continuously consistent degree of curvature of the wire segment would preclude insertion of a wire of significant stiffness. In addition, the closed-face tube attachment precludes the placement of significant arch-wire bends, therefore, it could only be considered practical if the attachment system is positioned with high precision and coordination of bracket positions.

As such, conventional bracket systems are designed to accommodate one bracket per tooth on either the facial or lingual side, but, as a practical matter, not both. They use open-face slots on anterior and most premolar teeth with tube attachments on the molar teeth. Note that many tube attachments designed for molars are also designed with a removable facial wall that allows the tube to be converted into an open-face bracket. Such designs also require the presence of tie-wings to hold the wire in place once the tube is converted to an open-face bracket.

In addition, because lingual side tooth anatomy is more highly variable among individual tooth types compared with facial side anatomy, using a “base-dependent” positioning system to achieve a “straight-wire” result is even more difficult than the traditional facial bracket system, even when an indirect method is utilized to position and bond brackets. That is, a “fixed bracket shape with a base” designed for the lingual tooth surface presents practical limitations due to the lack of consistent coordination between the bracket bases and the anatomy to which they are applied and thus creates a much less efficient system at achieving coordination of slot positions such that a straight wire could then deflect the teeth to the desired positions. Because of this inefficiency, greater effort and greater unpredictability are realized by the operator who attempts traditional lingual orthodontics and who needs to bend arch-wires to compensate for poorly coordinated lingual bracket slots.

If an operator desires the efficiency of a straight wire mechanical system to be used on the lingual side of teeth, this requires the ability to customize slot position for each patient. While this can theoretically be accomplished using a traditional bracket with a base and protruding tie-wings, the degree of protrusion and irregularity of shape (roughness) creates substantial discomfort for the patient. For this reason and others, lingual bracket systems have seen only very limited applications in orthodontics. Most patients, however, would prefer the brackets be attached lingually where they are much less visually noticeable.

In addition, the desirability of a high degree of adjustability of any fixed edgewise system has lead to the predominant use of open-faced slots on premolar and anterior teeth. In fact, open-faced slots are a practical necessity because of the obvious problems with insertion of full-length arch-wires through a closed-face bracket system. But with open-faced slots, the arch-wires must be secured in the slot, which is conventionally done by using ligature-ties tied around bracket tie-wings. These tie-wings create a relatively bulky, high profile bracket system and generally result in a highly irregular surface against which lips, cheeks, and tongue will rub and create discomfort.

Although indirect bonding methods present the opportunity for brackets to be positioned with far greater position than can be achieved using a direct method, the indirect methods have not seen widespread use because they present some degree of technical sensitivity that some practitioners cannot seem to overcome sufficiently to warrant full time, consistent usage. And even when an indirect method is utilized, there still exists significant opportunity for creating errors in positioning due to use of the relatively simple instruments for measuring available. Furthermore, limitations presented by brackets with bases limits the ultimate degree of precision and practicality that can be achieved regardless of the measuring device used.

Accordingly, there is a need for a device and method for positioning orthodontic brackets on teeth more accurately. Preferably, such a bracket positioning device and method should permit customizing the position and orientation of each bracket depending on the anatomy of the particular tooth. And the device and method should permit attaching the brackets to the lingual surface of the teeth so that the brackets are less visibly noticeable while also being comfortable. It is to the provision of such an orthodontic bracket positioning device and method that the present invention is primarily directed.

### SUMMARY OF THE INVENTION

One aspect of the present invention includes a device for positioning orthodontic brackets on model teeth as part of an indirect attachment method. After the brackets are positioned on the model teeth, the brackets are transferred to the patient's actual teeth, where they are attached and arch-wires are installed to form the completed orthodontic appliance, as is known in the art.

The positioning device has includes a base and a superstructure mounted on the base. The superstructure includes components for sequentially registering the position of each tooth in the model and precisely positioning the brackets relative to the model teeth in a coordinated fashion so that the bracket slots align in an arch when the orthodontic treatment is completed.

In an exemplary embodiment of the invention, the superstructure includes a turntable that is adjustably mounted to the base, and a platform adjustably mounted to the turntable. The platform is configured for securely mounting the teeth model. The superstructure further includes a mast that extends upwardly from the turntable, a masthead that extends outwardly from the mast, and a suspended portion of the superstructure that is adjustably mounted to the masthead. The superstructure suspended portion includes a series of support arms that provide for adjustment including vertical/linear, rotational in the horizontal plane, pivotal in one vertical plane, and pivotal in the other (perpendicular) vertical plane.

Another aspect of the invention is the provision of a composite register assembly, which is preferably mounted to the support arms of the superstructure. The composite register assembly includes components for accurately registering the vertical, axial, torque, rotational, and in-out values for each tooth and accurately positioning the bracket based on these values. Preferably, the composite register assembly includes a vertical register assembly, a torque register assembly, a rotational register assembly, and a bracket holder assembly, all mounted on a register frame. These subassemblies of the composite register assembly also include control/adjusting mechanisms and scales for indicating tooth-related measurements that they register. In addition, the torque register assembly and the bracket holder assembly are preferably interchangeable with each other, depending on whether the device is being used to lingual of facial bracket positioning, and a teeth model orienting assembly can also be interchanged with either subassembly position for use to level the model teeth.

In a typical commercial embodiment, the vertical register assembly includes a frame, two vertical register arms, and a control that horizontally adjusts the spaced apart width of the arms. The torque register assembly includes a body, a rotary register head mounted to the body. And the rotation register assembly includes a frame, two rotation register arms, and a control that horizontally adjusts the spaced apart width of the arms. The vertical register assembly and the torque register assembly are each spring-loaded, and the rotation register assembly rotates freely, so that these three assemblies are free-floating and can be adjusted without necessarily having to lock and release any controls. In addition, the vertical register arms and the torque register head are thereby biased toward engagement with the tooth being worked on so that as one of the register assemblies is adjusted the others tend to maintain their engagement.

The bracket holder assembly preferably includes a control that operates a bracket receiver mechanism. Preferably, the bracket receiver mechanism is configured to receive a clip that holds the brackets for positioning.

In yet another aspect of the invention, there is provided an indirect method of positioning orthodontic brackets on model teeth. An exemplary such method includes the step of selecting predetermined torque values, for example, values based on the average tooth anatomy of the general population.

The method further includes the step of providing one or more devices for registering tooth positions and positioning brackets, preferably, the device described herein. When using this preferred device, it is first set to its “ready” position by moving the subassemblies out of the way, and then the teeth model is mounted securely in place and leveled.

The method further includes the step of providing an orthodontic bracket suitable for positioning on the subject tooth. When using the preferred device, the bracket is preferably provided by one of the brackets described herein. More preferably, the bracket is loaded on the clip, which is loaded on the bracket holder assembly.

Then the “absolute vertical height” relative to the relevant “reference plane” is determined for each tooth in the appliance segment. An as example, if the reference plane for an upper arch of teeth is set at 3 mm, then the absolute values are as follows: upper central incisor 3 mm (−0.0 mm), lateral incisor 2.5 m (−0.5 mm), canine 3 mm (−0.0 mm), first premolar 2.5 mm (−0.5 mm), second premolar 2.0 mm (−1.0 mm), etc. These values can be recorded in the table for convenience.

The operator determines by visual inspection which tooth or teeth will likely limit the vertical placement of the brackets, and determines by visual inspection an approximate reference plane based on the known off-sets. The torque, rotation, axial, etc. positioning should be closely approximated for this “test run” but need not be precisely set. Recommended vertical offset and torque values are provided in the table.

Next, the horizontal plane bodily off-set value (“In-Out”) is determined for each tooth in the segment, and then the usable values can be determined. Preferably, the attachments are positioned as close to the tooth surface as possible on all teeth, so the widest (thickest) tooth will be the one considered the “limiting factor.” All other brackets are then offset relative to the thickest width tooth measured.

Then the bracket positioning and fixation sequence is performed on each tooth of a particular reference plane. Generally described, this step includes adjusting the free-floating vertical register assembly, torque register assembly, and rotation assembly, and then adjusting the bracket holder assembly to precisely position the bracket. With the bracket held in a suspended position offset from the model tooth surface and oriented so that its opening will be coordinated with the adjacent bracket openings to form a smooth and continuous arch-shaped wire pathway upon completion of the orthodontic treatment, it is then adhered in place to the teeth model using a conventional adhesive. And then the bracket is disengaged from the bracket holder assembly.

These steps are then repeated for each tooth/bracket in a segment or reference plane of the appliance. In this way, appliances with several overlapping segments can be made to form a continuous arch.

Accordingly, the present invention provides for positioning orthodontic brackets on teeth with much more accuracy, flexibility, customization, and coordination with adjacent brackets than was previously available. Because of this positioning capability, the brackets can be attached to lingual and/or facial tooth surfaces and used to reposition the teeth to very close to their ideal position using a straight wire concept. Furthermore, this can be done with far fewer number and degree of manipulations of the wires and more quickly and with less patient discomfort than was previously available.

The specific techniques and structures employed by the invention to improve over the drawbacks of the prior devices and accomplish the advantages described herein will become apparent from the following detailed description of the exemplary embodiments of the invention and the appended drawings and claims.

### BRIEF DESCRIPTION OF THE DRAWINGS

FIG. 1 is a front side view of a device for positioning orthodontic brackets on teeth according to a first exemplary embodiment of the present invention, showing a base and a superstructure.

FIG. 2 is a right side view of the positioning device of FIG. 1.

FIG. 3 is a top perspective view of the positioning device of FIG. 1.

FIG. 4 is a bottom perspective view of the positioning device of FIG. 1.

FIG. 5 is cross section view of the positioning device of FIG. 1, taken at line 5-5 of FIG. 2.

FIG. 6 is a left perspective view of a suspended portion of the superstructure of the positioning device of FIG. 1, showing a bracket holder assembly, a vertical register assembly, a rotation register assembly, and a torque register assembly.

FIG. 7 is a left perspective view of the superstructure portion of FIG. 6, showing the torque register assembly temporarily removed and a teeth model orienting plate installed in its place.

FIG. 8 is a right perspective view of the superstructure portion of FIG. 6, showing the torque register assembly removed and the bracket holder assembly moved to its place.

FIG. 9 is a right side view of the positioning device of FIG. 1, showing a model of a patient's teeth being mounted onto a platform.

FIG. 10 is a detail view of the model teeth and the platform of FIG. 9.

FIG. 11 is a right side view of the positioning device of FIG. 9, showing the model teeth mounted on the platform with a centerline through the exposed surface of the teeth non-horizontally positioned.

FIG. 12 is a right side view of the positioning device of FIG. 11, showing the platform moved to horizontally orient the model teeth.

FIG. 13 is a right side view of the positioning device of FIG. 11, showing the superstructure movable in the horizontal plane to orient the superstructure and the model teeth relative to the user.

FIG. 14 is a cross section view of the positioning device taken at line 14-14 of FIG. 13.

FIG. 15 is a cross section view of the positioning device of FIG. 14, showing the suspended portion of the superstructure movable in the horizontal plane for orientation directly over the model teeth.

FIG. 16 is a detail view of the superstructure portion movement of FIG. 15.

FIG. 17 is a cross section view of the positioning device of FIG. 15, showing the superstructure portion suspended over the model teeth.

FIG. 18 is a cross section view of the positioning device of FIG. 17, showing the superstructure suspended portion lowered down to the model teeth.

FIG. 19 is a front side view of a portion of the superstructure of the positioning device of FIG. 18, showing a composite register assembly including the vertical register assembly.

FIG. 20 is a front side view of the superstructure portion of FIG. 19, showing the composite register assembly being pivoted downward.

FIG. 21 is a front detail view of the vertical register assembly of FIG. 19, showing two vertical register arms positioned together for use on a canine tooth.

FIG. 22 is a front detail view of the vertical register assembly of FIG. 19, showing the two vertical register arms being horizontally spaced for use on a molar tooth.

FIG. 23 is a front detail view of the vertical register assembly of FIG. 19, showing the two vertical register arms being horizontally spaced for use on an incisor tooth.

FIG. 24 is a front detail view of the vertical register assembly of FIG. 23, showing it vertically moved down so that one of the vertical register arms is on the edge of the tooth.

FIG. 25 is a front detail view of the vertical register assembly of FIG. 24, showing it pivoted down so that the second vertical register arm is also on the edge of the tooth.

FIG. 26 is a right side view of the positioning device of FIG. 19, showing the torque register assembly ready for positioning.

FIG. 27 is a right detail view of the positioning device of FIG. 26, showing the torque register assembly being vertically moved into position.

FIG. 28 is a right detail view of the positioning device of FIG. 27, showing the torque register assembly being horizontally moved into position.

FIG. 29 is a right detail view of the positioning device of FIG. 28, showing a rotary register head of the torque register assembly engaging the facial tooth surface.

FIG. 30 is a perspective view of a portion of the superstructure of the positioning device of FIG. 26, showing the composite assembly being pivoted sideways.

FIG. 31 is a right detail view of the superstructure portion of FIG. 27, showing the torque register assembly engaging the facial tooth surface.

FIG. 32 is a right detail view of the superstructure portion of FIG. 31, showing the composite assembly being pivoted sideways to adjust the torque registered by the torque register assembly to the desired value.

FIG. 33 is a right detail view of the vertical register assembly in the position of FIG. 22 and the torque register assembly horizontally moved into position with the rotary register head engaging the facial surface of a premolar tooth.

FIG. 34 is a right detail view of the vertical register assembly in the position of FIG. 22 and the torque register assembly horizontally moved into position with the rotary register head engaging the facial surface of a molar tooth.

FIG. 35 is a side view of the torque register assembly of FIG. 26, showing a body with the rotary register head mounted to it.

FIG. 36 is an end view of the torque register assembly of FIG. 35.

FIG. 37 is a perspective view of the register head of the torque register assembly of FIG. 35.

FIG. 38 is a perspective view of a portion of the body of the torque register assembly of FIG. 35, showing a spring-loaded mounting of the register head.

FIG. 39 is a side cross-sectional view of the torque register assembly of FIG. 35, showing the spring-loaded mounting of the register head

FIG. 40 is a side cross-sectional view of the torque register assembly of FIG. 39, showing the spring-loaded rotary movement of the register head.

FIG. 41 is a plan view of the torque register assembly of FIG. 35, showing a torque gauge that registers the torque value.

FIG. 42 is a right side view of the positioning device of FIG. 32, showing the rotational movement of the composite assembly.

FIG. 43 is a bottom view of the superstructure of the positioning device of FIG. 42, showing the rotational movement of the composite assembly including the rotation register assembly.

FIG. 44 is a bottom detail view of the rotation register assembly of FIG. 43, showing two rotation register arms being rotated onto an incisor tooth.

FIG. 45 is a bottom detail view of the rotation register assembly of FIG. 44, showing both rotation register arms now rotated onto the incisor tooth.

FIG. 46 is a perspective view of the rotation register assembly in the position of FIG. 45 and the vertical register assembly in the position of FIG. 25.

FIG. 47 is a front detail view of the rotation register assembly of FIG. 46, showing the two rotation register arms rotated onto the heights of convexity of the incisor tooth.

FIG. 48 is a bottom detail view of the rotation register assembly of FIG. 47.

FIG. 49 is a front detail view of the rotation register assembly of FIG. 46, except showing the two rotation register arms rotated onto the heights of convexity of a molar tooth.

FIG. 50 is a bottom detail view of the rotation register assembly of FIG. 49.

FIG. 51 is a front detail view of the rotation register assembly of FIG. 46, except showing the two rotation register arms rotated onto the heights of convexity of a canine tooth.

FIG. 52 is a bottom detail view of the rotation register assembly of FIG. 51.

FIG. 53 is a right side view of the composite register assembly of FIG. 46, showing the rotation register assembly being vertically moved into position.

FIG. 54 is a right side view of the composite register assembly of FIG. 53, showing the rotation register assembly being horizontally moved into position.

FIG. 55 is a right side view of the composite register assembly of FIG. 46, showing the bracket holder assembly being vertically and horizontally moved into position.

FIG. 56 is a right side view of the composite register assembly of FIG. 55, showing the bracket holder assembly positioning the bracket on the lingual surface of the incisor tooth.

FIG. 57 is a right side view of the composite register assembly of FIG. 8, showing the torque register assembly removed and the bracket holder assembly moved to its place for positioning the bracket on the facial tooth surface.

FIG. 58 is a right side view of the composite register assembly of FIG. 57, showing the bracket holder assembly positioning the bracket on the facial tooth surface.

FIG. 59 is a side view of the bracket holder assembly of FIG. 56, showing it being opened to receive a clip holding a bracket.

FIG. 60 is a side view of the bracket holder assembly of FIG. 59, showing it being closed to grasp the clip.

FIG. 61 is a side view of the bracket holder assembly of FIG. 60, showing it being reopened to release the clip so that it can then receive another one.

FIG. 62 is a cross section view of the bracket holder assembly grasping the clip, taken at line 62-62 of FIG. 60, showing the keying of the clip and grasper.

FIG. 63 is a plan view of the clip of FIG. 59.

FIG. 64 is a side view of the clip of FIG. 63.

FIG. 65 is a plan view of the clip of FIG. 63 holding the bracket, showing a clip finger received in a bracket opening.

FIG. 66 is a side view of a first exemplary bracket for use with the clip of FIG. 59 on molar teeth.

FIG. 67 is a side view of a first exemplary attachment made using the bracket of FIG. 66, showing the attachment formed on a molar tooth.

FIG. 68 is a perspective view of a second exemplary bracket for use with the clip of FIG. 59 on incisor teeth.

FIG. 69 is a side view of a second exemplary attachment made using the bracket of FIG. 68, showing the attachment formed on an incisor tooth.

FIG. 70 is a plan view of an arch of teeth showing an orthodontic appliance including the attachments of FIG. 67 on lingual surfaces of anterior teeth and two sets of the attachments of FIG. 69 on facial surfaces of posterior teeth.

FIG. 71 is a table for recording the values to be registered when using the device of FIG. 1 to position the brackets.

FIG. 72 is the table of FIG. 71 with the values recorded by the operator.

### DETAILED DESCRIPTION OF EXEMPLARY EMBODIMENTS

In describing the exemplary embodiments of the present invention, the following terms and their respective definitions are used. “Rotation” refers to the rotational movement (i.e., spin) of a tooth in the horizontal plane and around the long axis of the tooth. “Axial” refers to the rotational movement (i.e., tipping) of a tooth in the vertical plane in the mesial-distal direction. “Torque” refers to the rotational movement of a tooth in the vertical plane in the facial-lingual direction (i.e., around the axis formed by the arch-wire). “In-out” refers to bodily tooth movement horizontally in the facial and lingual directions. “Vertical” refers to bodily tooth movement up or down in the occlusal or gingival directions. And “teeth” or “tooth” mean not just a patient's actual teeth or tooth, by are also generally intended to mean those of a model of the patient's teeth.

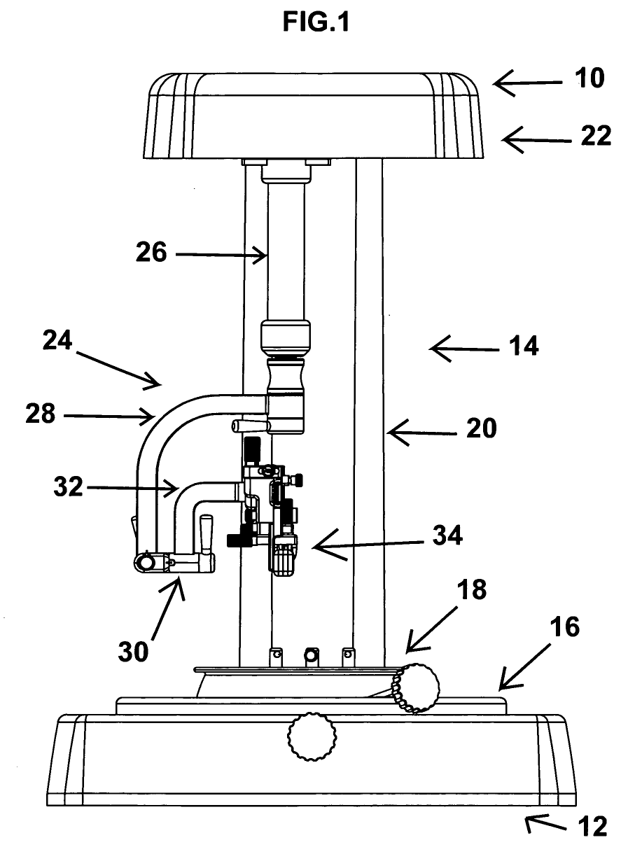

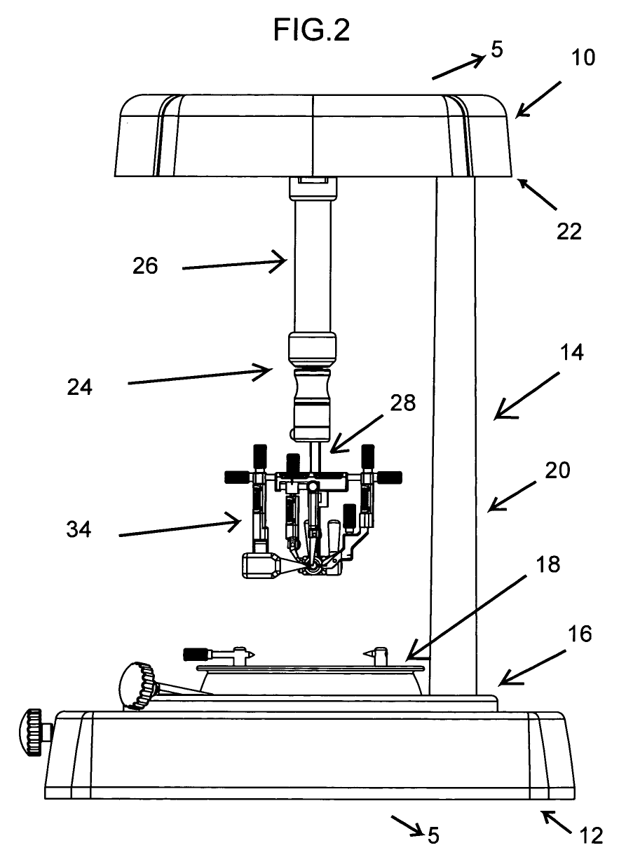

Referring to the drawings, FIGS. 1-5 illustrate a device 10 for positioning orthodontic brackets according to a first exemplary embodiment of the present invention. The device 10 is typically used as part of an indirect attachment method to position the brackets on a teeth model. After the brackets are positioned on the teeth model, the brackets are transferred to the patient's actual teeth, where they are attached and arch-wires are installed to form the completed orthodontic appliance.

The positioning device 10 includes a base 12 and a superstructure 14 mounted to the base. The base 12 has a flat bottom for stability when placed on a countertop or table. In alternative embodiments, the base has floor-standing legs and/or is otherwise configured for the particular working environment.

The superstructure 14 includes a turntable 16 that is adjustably mounted to the base 12, and a platform 18 adjustably mounted to the turntable. The platform 18 is configured for securely mounting the teeth model. The superstructure 14 further includes a mast 20 that extends upwardly from the turntable 16, a masthead 22 that extends outwardly from the mast, and a suspended portion 24 of the superstructure that is adjustably mounted to the masthead. The superstructure suspended portion 24 includes a first support arm 26 that is vertically adjustable, a second support arm 28 that is rotationally adjustable in the horizontal plane, a third support arm 30 that is pivotally adjustable in a vertical plane, and a fourth support arm 32 that is pivotally adjustable in a vertical plane perpendicular to that of the third support arm. Mounted to the fourth support arm 32 is a composite register assembly 34 that includes components for accurately registering the vertical, axial, torque, rotational, and in-out values for each tooth and accurately positioning the bracket based on these values. The components of the superstructure 14 and their respective operation are described in detail below.

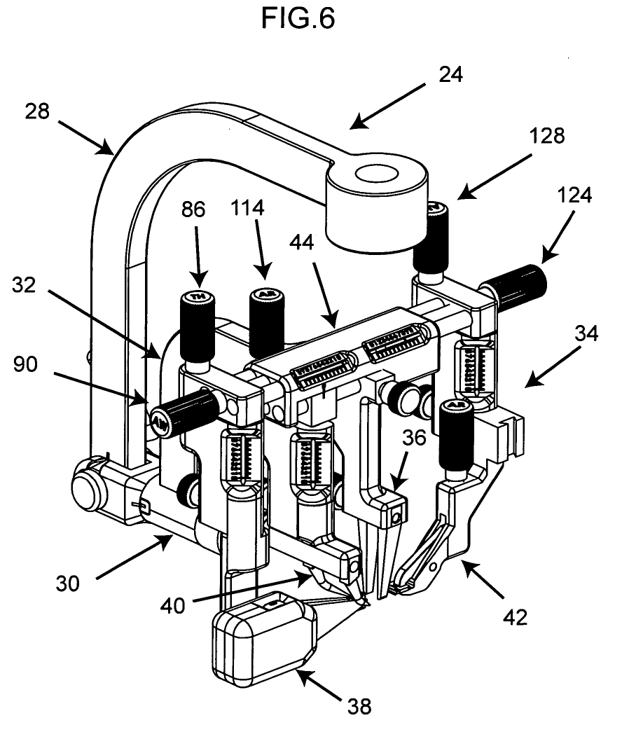

FIG. 6 shows the suspended portion 24 of the superstructure 14, including the composite register assembly 34. The composite register assembly 34 includes a vertical register assembly 36, a torque register assembly 38, a rotational register assembly 40, and a bracket holder assembly 42, all mounted on a register frame 44. With the composite register assembly 34 in this configuration, the device 10 is set up for positioning the brackets on the lingual surface of the teeth. These subassemblies of the composite register assembly 34 also include adjusting mechanisms and other components, which are described in detail below.

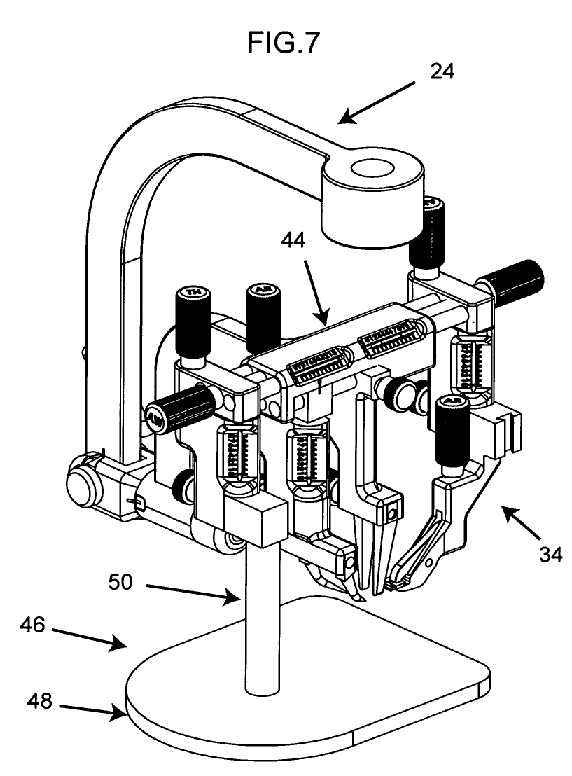

FIG. 7 shows the suspended portion 24 of the superstructure 14, including the composite register assembly 34 in another configuration. In this figure, the torque register assembly has been removed from the register frame 44 and a teeth model orienting assembly 46 installed in its place. The teeth model orienting assembly 46 includes an engagement member such as a plate 48 and a mounting member such as an upwardly extending arm 50 for vertical adjustment and attachment to the register frame 44. Preferably, the plate 48 is flat and horizontally oriented. In alternative embodiments, the plate 48 is angled to generally conform to the average front-to-rear angle of teeth cusps, an engagement member other than a plate is provided, and/or another mounting member is provided. The use of the teeth model orienting assembly 46 is further described below.

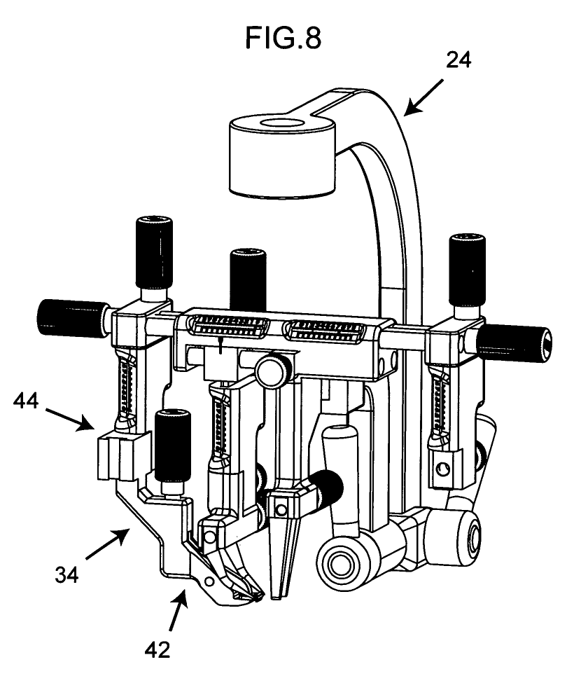

FIG. 8 shows the suspended portion 24 of the superstructure 14, including the composite register assembly 34 in still another configuration. In this figure, the torque register assembly has been removed from the register frame 44 and the bracket holder assembly 42 has been moved from its position in FIG. 6 to where the torque register assembly was. With the composite register assembly 34 in this configuration, the device 10 is set up for positioning the brackets on the facial surface of the teeth.

As can be seen from FIGS. 6-8, the composite register assembly 34 has interchangeability features that permit the torque register assembly 38, the teeth model orienting assembly 46, and the bracket holder assembly 42 to be readily repositioned on the register frame 44 and interchangeably used with different controls and scales (described below) on the frame, depending on the particular task at hand. Accordingly, the register frame 44 and these assemblies 38, 42, and 46 are configured with similar or compatible attachment mechanisms. For example, the attachment mechanisms may include dove-tailed slots and mating tabs for receipt in the slots, holes and pins for extending through the holes, and/or other conventional attachment mechanisms.

Furthermore, other types of vertical register assemblies, torque register assemblies, rotational register assemblies, bracket holder assemblies, and teeth model orienting assemblies can be incorporated into the exemplary device 10. And the exemplary vertical register assembly 36, torque register assembly 38, rotational register assembly 40, bracket holder assembly 42, and teeth model orienting assembly 46 described herein can be incorporated into other positioning devices.

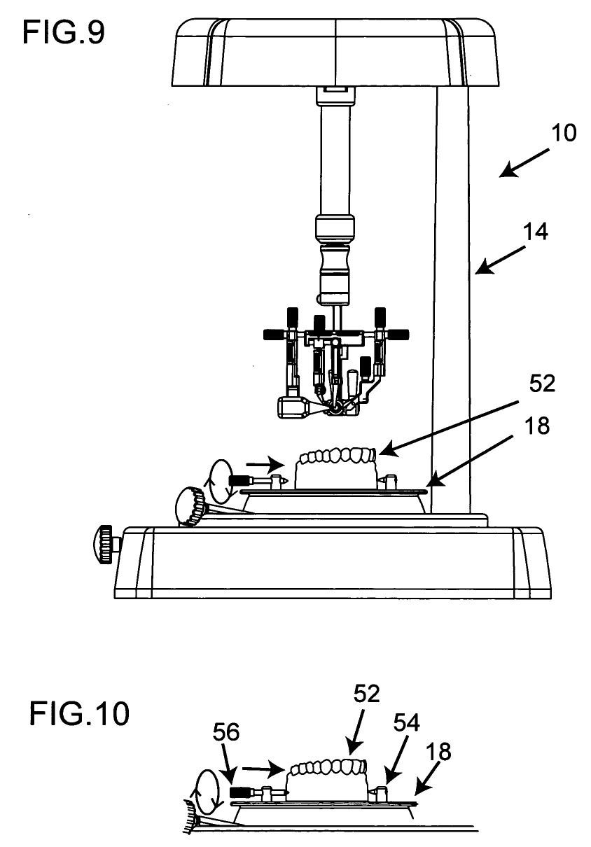

The operation and additional details of the device 10 will now be described. FIGS. 9 and 10 show a model 52 of a patient's teeth being mounted onto the platform 18 of the superstructure 14 of the positioning device 10. The platform 18 has a mounting mechanism for securing the teeth model 52 in place. In a typical commercial embodiment, the mounting mechanism has three mounting pins 54, at least one of which has an adjustment mechanism 56 for tightening to and releasing from the teeth model 52. For example, the adjustment mechanism 56 may be provided by a pin that is threaded and has a control knob, with the pin moving laterally (shown by the horizontal arrow) upon rotation of the control knob (shown by the rotational arrow). It will be understood that other conventional mounting mechanisms may be provided.

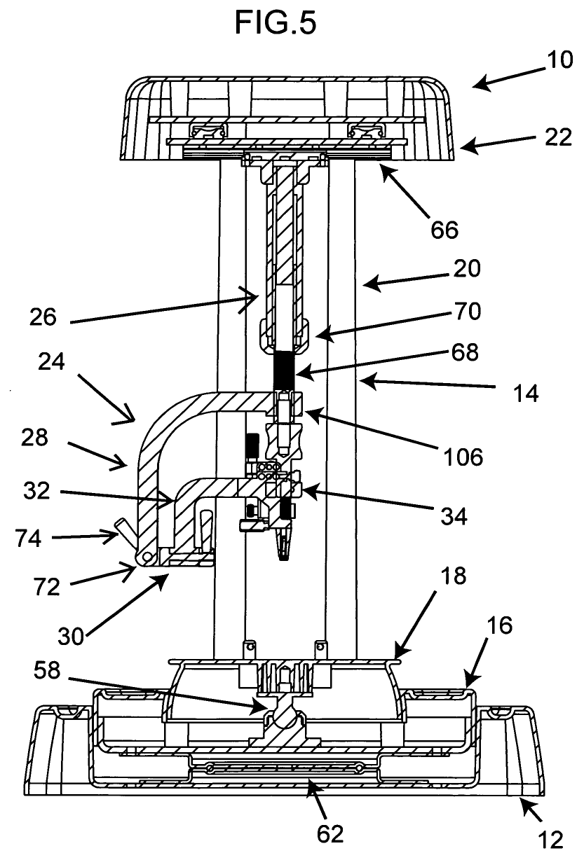

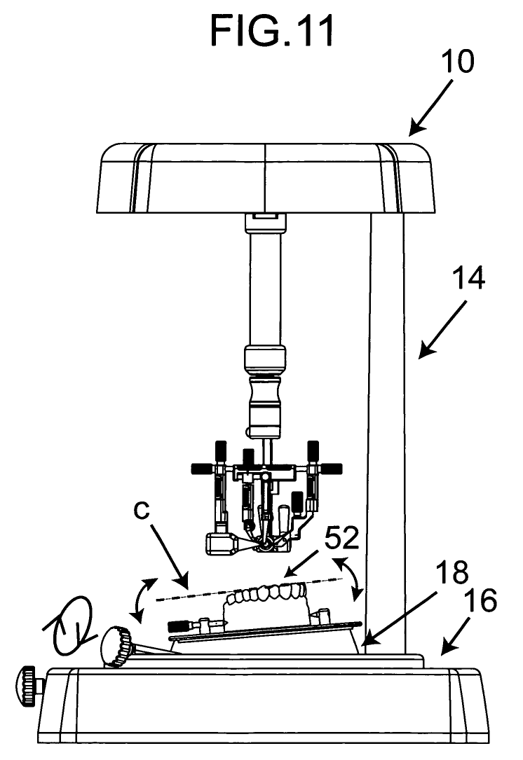

FIGS. 11 and 12 show the platform 18 of the superstructure 14 of the positioning device 10 being adjusted to orient the teeth model 52. Preferably, the teeth model 52 is oriented with a centerline C through the exposed surface of the teeth in a horizontal position (see FIG. 12). This makes later adjustments using the composite register 34 smaller because the teeth are more uniformly positioned relative to the composite register. The teeth model 52 can be approximately oriented by visual inspection. Or for more precision, the teeth model orienting assembly 46 can be installed and used to orient the teeth model 52 (see FIG. 7). The adjustability of the platform 18 is provided by a three-dimensional movement coupling 58 (see FIG. 5) to the turntable 16 and a control 60. In a typical commercial embodiment, the three-dimensional movement coupling 58 is provided by a ball joint and the control 60 is provided by a frictional locking and release mechanism. It will be understood that other conventional three-dimensional movement couplings and controls may be provided.

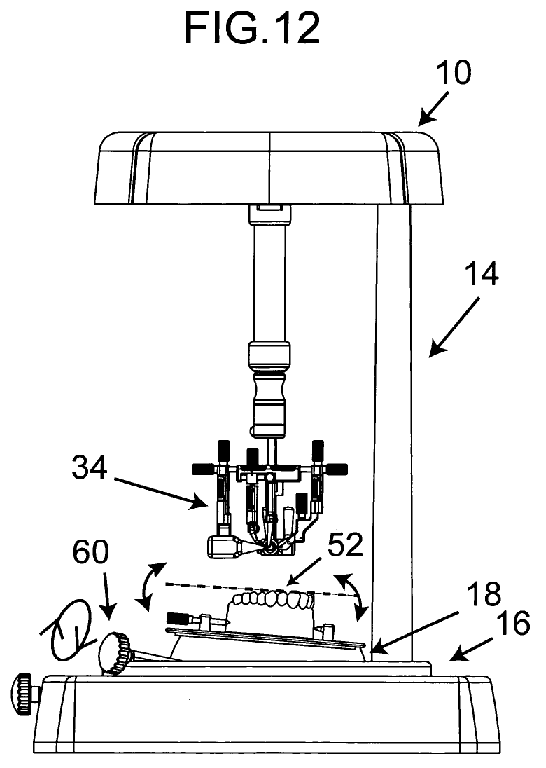

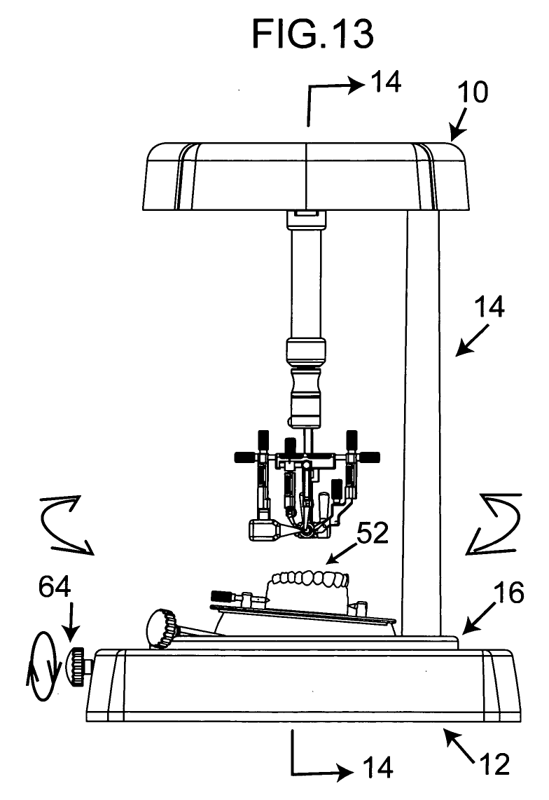

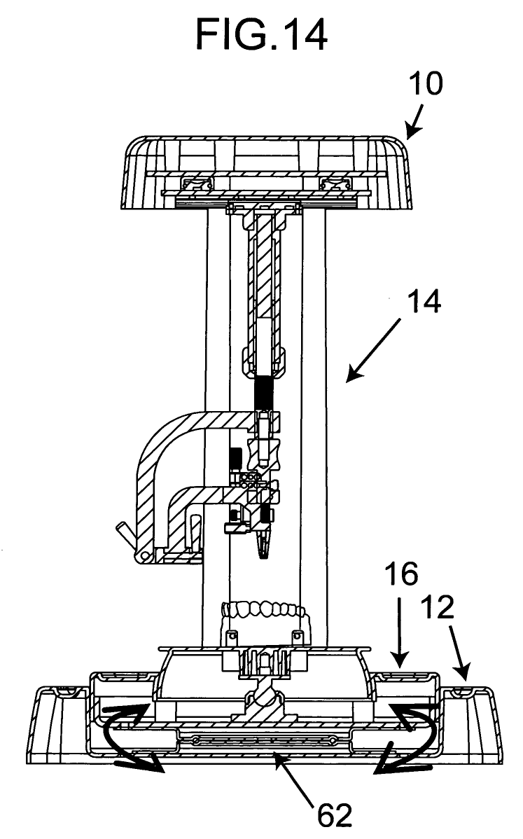

FIGS. 13 and 14 show the superstructure 14 of the positioning device 10 being rotated in the horizontal plane to selectively orient the teeth model 52 and the composite register 34 for the operator's convenience. As the operator positions one of the brackets on one of the model teeth 52 and then moves on to the next tooth, the operator can move the superstructure 14 so that next tooth is in front of him. This prevents neck strain from the operator having to constantly move to orient himself to the tooth he is working on. The adjustability of the superstructure 14 is provided by a rotational coupling 62 (see FIG. 5) between the turntable 16 and the base 12, and a control 64. In a typical commercial embodiment, the rotational coupling 62 is provided by a roller bearing and the control 64 is provided by a frictional locking and release mechanism. It will be understood that other conventional rotational couplings and controls may be provided.

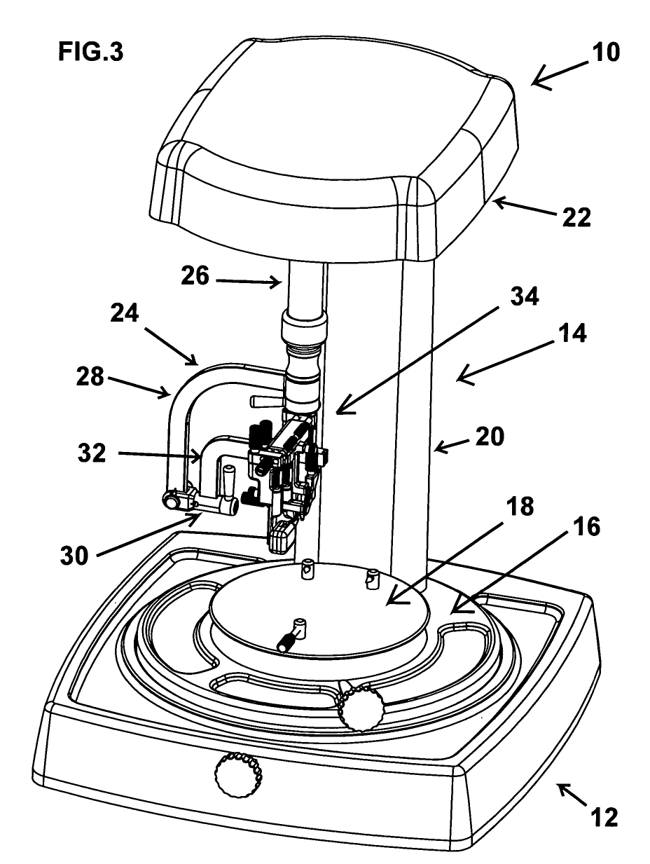

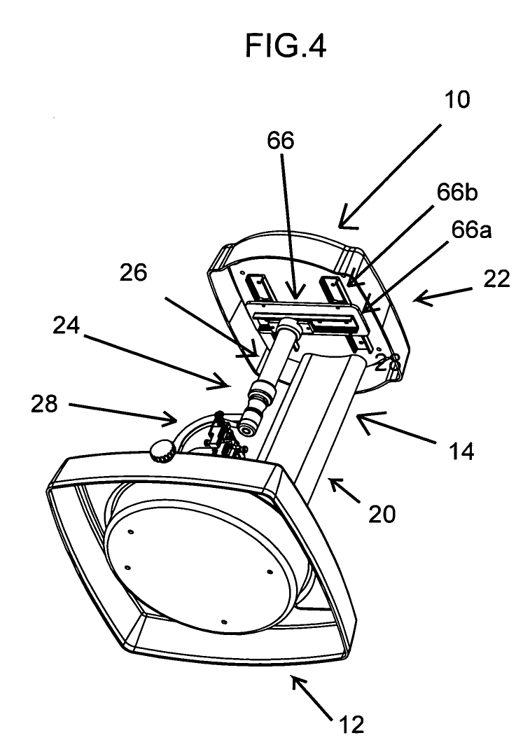

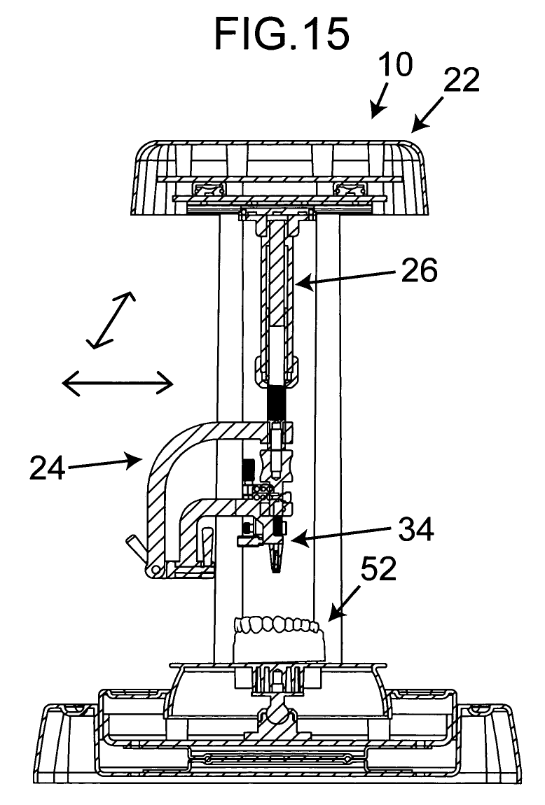

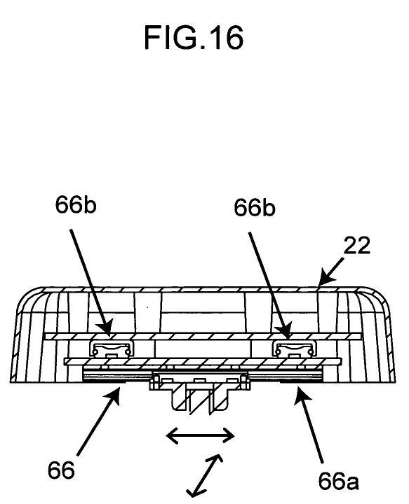

FIGS. 15 and 16 show the suspended portion 24 of the superstructure 14 being adjusted in the horizontal plane for orienting the composite register assembly 34 directly over the particular tooth 52 being worked on. The adjustability of the superstructure suspended portion 24 is provided by a horizontal sliding mechanism 66 (see FIGS. 4 and 5) between the masthead 22 and the first support arm 26. In a typical commercial embodiment, the horizontal sliding mechanism 66 is provided by one side-to-side roller bearing 66a supporting the first support arm 26, and two front-to-back roller bearings 66b supporting the side-to-side roller bearing and mounted to the masthead 22. In addition, the horizontal sliding mechanism 66 may include a control (not shown), for example, a frictional locking and release mechanism. It will be understood that other conventional horizontal sliding mechanisms may be provided.

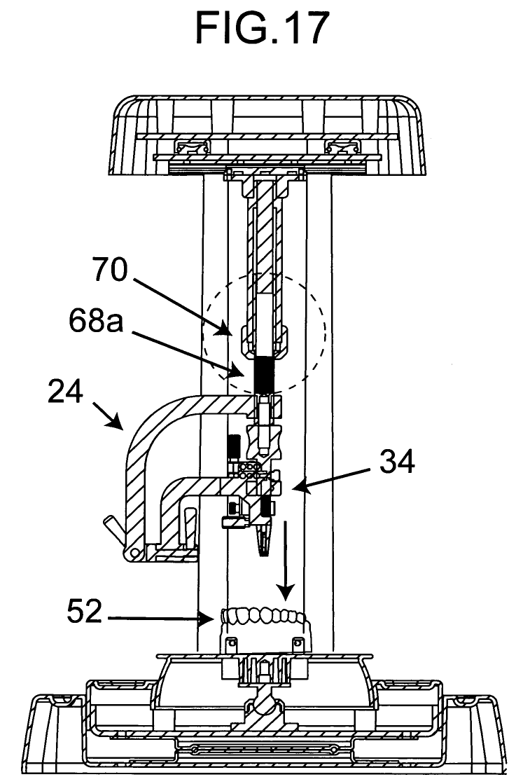

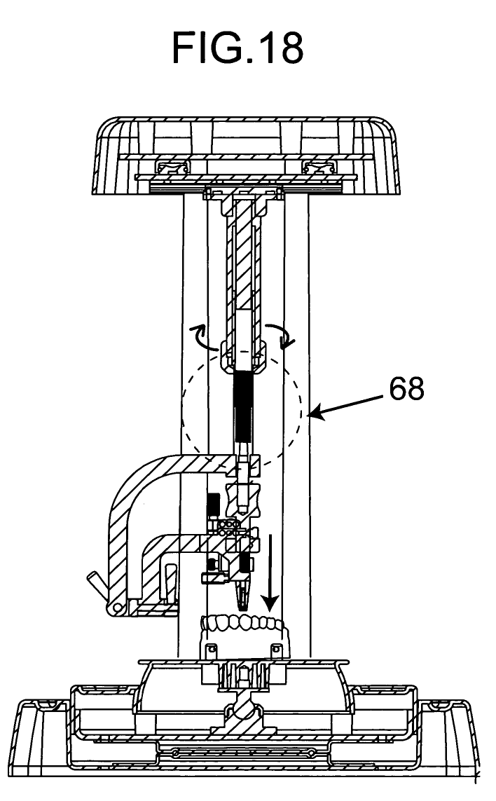

FIGS. 17 and 18 show the suspended portion 24 of the superstructure 14 being adjusted to vertically lower the composite register assembly 34 down to the model teeth 52. This adjustability of the superstructure suspended portion 24 is provided by a vertical sliding mechanism 68 (see FIG. 5) between the first support arm 26 and the second support arm 28, and a control 70. In a typical commercial embodiment, the vertical sliding mechanism 68 includes a spring-loaded support arm 68a telescopically slidable relative to the first support arm 26 and the control 70 is provided by a frictional locking and release mechanism. The spring-loading is selected to provide not quite enough of an upward force to support the weight of the other components of the suspended portion 24. In this way, the composite register assembly 34 will rest on the teeth 52 with a light downward force, but can be easy lifted for repositioning as needed (assuming that the control 70 is not locked). In alternative embodiments, the vertical sliding mechanism 68 includes multiple bars that slide relative to each other and are guided by one or more elongated slot and pin mechanisms, roller bearings, etc. It will be understood that other conventional vertical sliding mechanisms and controls may be provided.

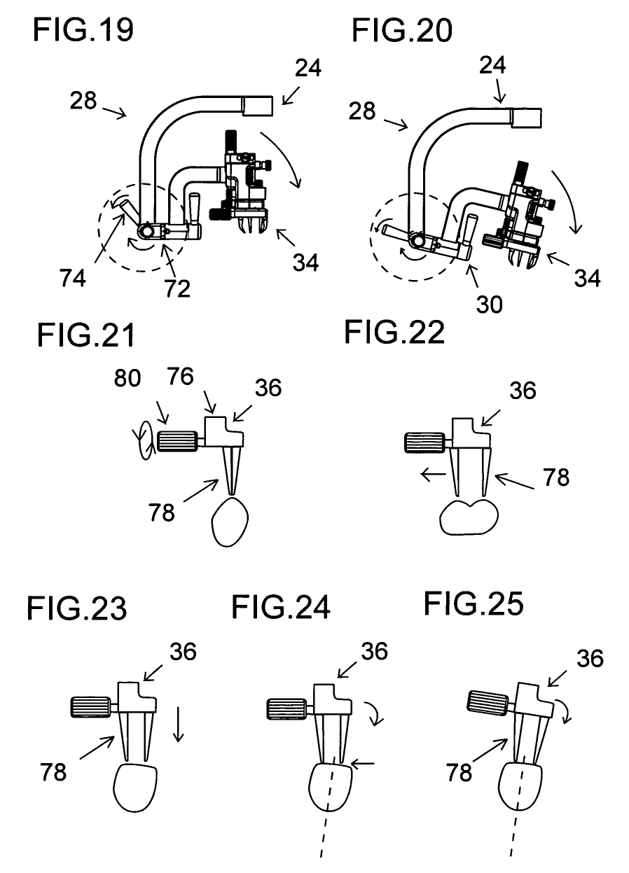

FIGS. 19 and 20 show the suspended portion 24 of the superstructure 14 being adjusted to pivot the composite register assembly 34 downward in a vertical plane for precisely positioning the vertical register assembly 36. This adjustability of the superstructure suspended portion 24 is provided by a pivotal coupling 72 (see FIG. 5) between the second support arm 28 and the third support arm 30, and a control 74. In a typical commercial embodiment, the pivotal coupling 72 is provided by a journaled bearing and the control 74 is provided by a frictional locking and release mechanism. It will be understood that other conventional pivotal couplings and controls may be provided.

FIG. 21 shows details of the vertical register assembly 36, which includes a frame 76, two vertical register arms 78, and a control 80 that horizontally adjusts the spaced apart width of the arms. In a typical commercial embodiment, the adjustable width control 80 includes a rack-and-pinion gear mechanism. In alternative embodiments, the vertical register assembly 36 includes only one register arm provided by a panel that is wide enough to register all typical teeth without adjustment, and/or the vertical register assembly includes another number and/or type of register arms. It will be understood that another conventional adjustable width control mechanism may be provided.

FIG. 21 shows the two vertical register arms 78 positioned together for registering the tip of a canine tooth, which has a pointy cusp. FIG. 22 shows the two vertical register arms 78 horizontally spaced for registering the tips of a molar tooth. And FIG. 23 shows the two vertical register arms 78 horizontally spaced for registering the flat edge of an incisor tooth. In this case, however, the flat edge of the mal-occluded tooth is slightly angled, so only one of the vertical register arms 78 engages the tooth. FIGS. 24 and 25 show the vertical register assembly 36 being pivoted downward with the composite register assembly 34 (as shown in FIG. 20) until the second vertical register arm 78 also engages the flat edge of the tooth for proper registration of the tooth. In this way, the vertical register assembly 36 registers not just the vertical position of the tooth but also its axial angle.

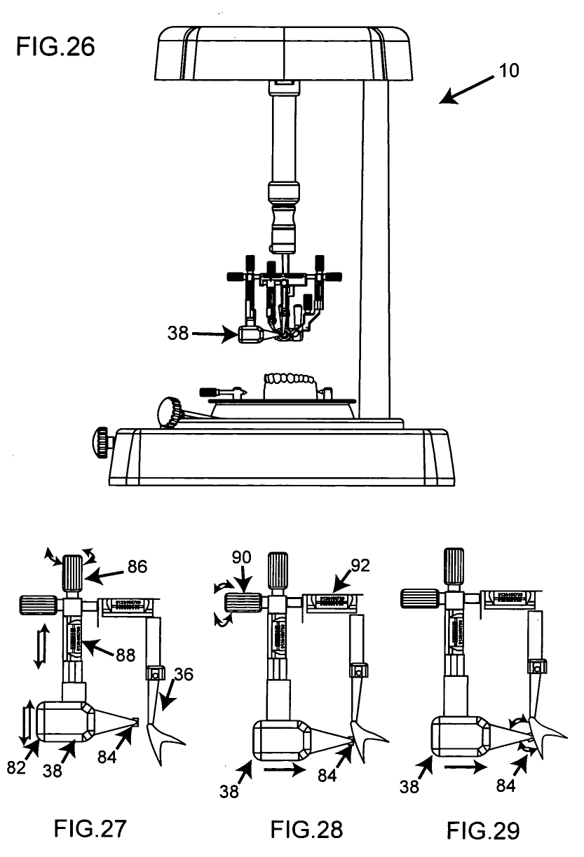

With the vertical register assembly 36 now in position, FIGS. 26-29 show the operation of the torque register assembly 38 to register an incisor tooth. The torque register assembly 38 includes a body 82, a rotary register head 84 mounted to the body, and a vertical control 86, a vertical scale 88, a horizontal control 90, and a horizontal scale 92 mounted on the frame 44 of the composite register assembly 34 (see FIG. 6). In a typical commercial embodiment, the vertical and horizontal controls 86 and 90 are provided by rack-and-pinion gear mechanisms and the vertical and horizontal scales 88 and 92 register the vertical and horizontal values in millimeters. It will be understood that other conventional vertical and horizontal control mechanisms and scales may be provided.

FIG. 27 shows the vertical control 86 being operated to move the register head 84 vertically into position at about the vertical mid-pojnt of the facial tooth surface. FIG. 28 shows the horizontal control 90 being operated to move the register head 84 horizontally into engagement with the facial tooth surface. And FIG. 29 shows the register head 84 engaging and rotating to flush against the facial tooth surface, thereby registering the torque angle of the facial surface of the mal-occluded tooth.

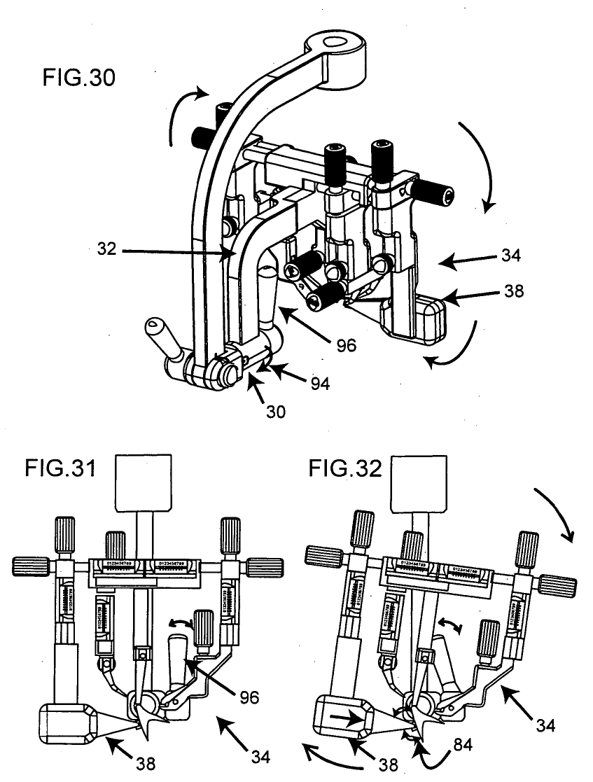

With the existing torque angle registered by the torque register assembly 38, FIGS. 30-32 shows the composite register assembly 34 being pivoted sideways in a vertical plane to adjust the torque register assembly 38 until it registers a predetermined torque value. The predetermined torque values may be based on the average torque value for the population because these values do not tend to vary widely. The torque register assembly 38 is spring-loaded with a forward pressure to maintain engagement of the register head 84 with the tooth during this adjustment (compare FIGS. 31 and 32). The pivotal adjustability of the composite register assembly 34 is provided by a pivotal coupling 94 (see FIG. 5) between the third support arm 30 and the fourth support arm 32, and a control 96. In a typical commercial embodiment, the pivotal coupling 94 is provided by a journaled bearing and the control 96 is provided by a frictional locking and release mechanism. It will be understood that other conventional pivotal couplings and controls may be provided.

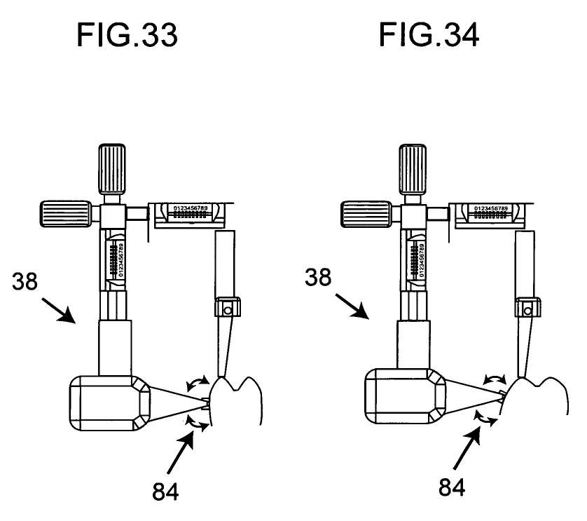

FIG. 33 shows the register head 84 of the torque register assembly 38 engaging the facial surface of a premolar tooth. And FIG. 34 shows the register head 84 of the torque register assembly 38 engaging the facial surface of a molar tooth. In both of these figures, the vertical register assembly is in the position of FIG. 22.

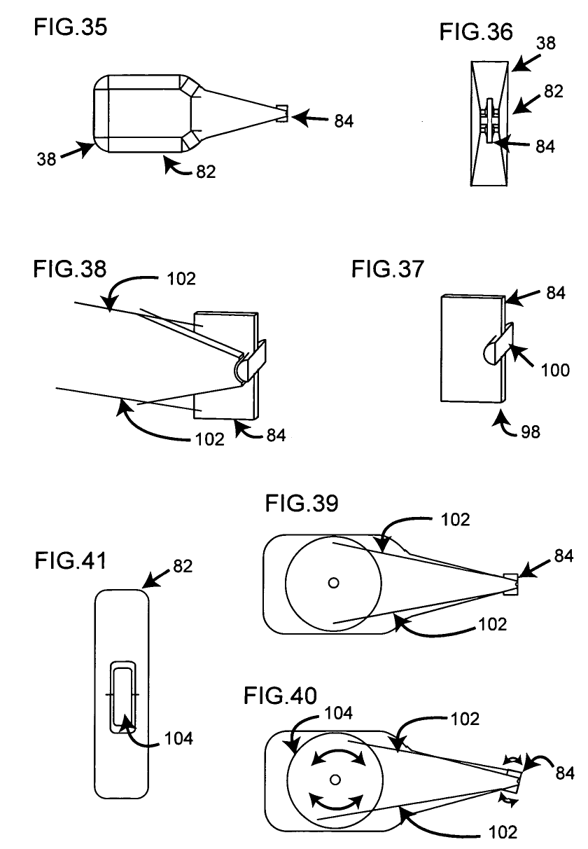

FIGS. 35-41 show additional details of the torque register assembly 38, including the body 82 and the register head 84. The register head 84 is rotationally mounted to the body 82 and spring-loaded. In a typical commercial embodiment, the register head 84 includes a plate 98 and a perpendicular member 100 with a semi-circular cross-section that cooperate to form a cross-shaped engagement surface (see FIGS. 36 and 37) for registration in two dimensions. In addition, the rotational mounting is preferably provided by a pin extending from the register head 84 that is rotationally received in an opening in the body 82. And the spring-loading is preferably provided by two spring members 102 such as coil springs or elastic cords. FIG. 40 shows the spring-loaded rotary movement of the register head 84, with the springs 102 connected to a torque scale 104 that moves to register the torque value (preferably in degrees). FIG. 41 shows the registered value on the torque scale 104 visible though an opening in the body 81. It will be understood that other conventional rotational mounting and spring-loading mechanisms, register head configurations, and torque scales may be provided.

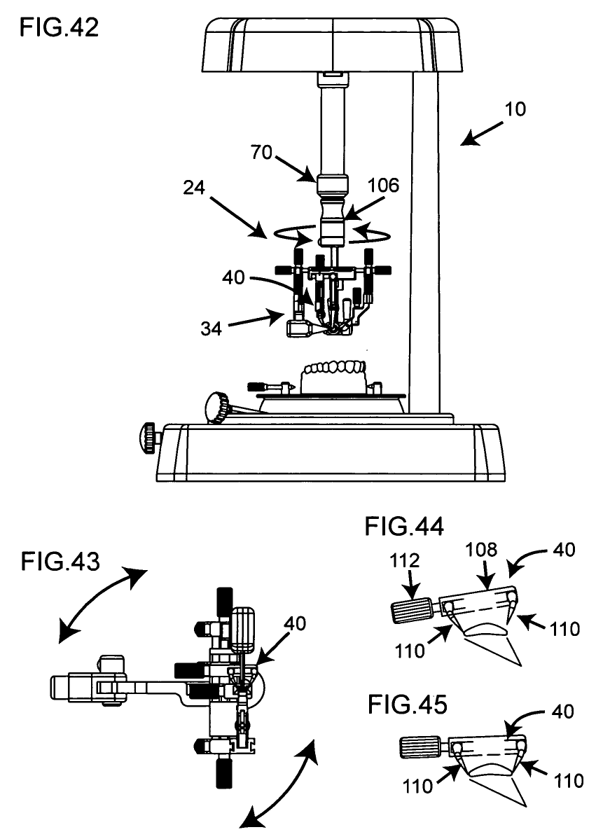

Having registered the vertical, axial, and torque values, FIGS. 42-45 show the use of the rotation register assembly 40 to register the rotation values. FIGS. 44 and 45 show details of the rotation register assembly 40, which includes a frame 108, two rotation register arms 110, and a control 112 that horizontally adjusts the spaced apart width of the arms. In a typical commercial embodiment, the adjustable width control 112 includes a rack-and-pinion gear mechanism and the rotation arms are inwardly angled. In alternative embodiments, the rotation register assembly 40 includes another number and/or type of register arms. It will be understood that another conventional adjustable width control mechanism may be provided.

FIGS. 42 and 43 show the rotational movement of the composite register assembly 34 for precisely positioning the rotation register assembly 40. This adjustability of the rotation register assembly 40 is provided by a rotational coupling 106 (see FIG. 5) between the first support arm 26 and the second support arm 28. In a typical commercial embodiment, the rotational coupling 106 is provided by a journaled bearing. In an alternative embodiment, the rotational coupling 106 is integral to the telescopic vertical sliding mechanism 68 (see FIGS. 18 and 19). In addition, the rotation register assembly 40 may include a control, such as a screw-down frictional locking and release mechanism. It will be understood that other conventional pivotal couplings and controls may be provided.

FIGS. 44 and FIG. 45 show that, by this rotation, the rotation register arms 110 are rotated into engagement with the inter-proximal heights of convexity of an incisor tooth. The inter-proximal heights of convexity are the points where adjacent teeth should ideally meet. The rotation register arms 110 are now set in a position defining a line that is coordinated with the tooth surface, that is, parallel to the line defining the ideal rotational position of the tooth, which in turn permits the bracket to be similarly positioned. Alternatively, the rotation register arms 110 can be set to a anther reference point such as the center of the tooth's facial surface at a particular vertical height or at dual contact points on the tooth's facial surface at a particular vertical height.

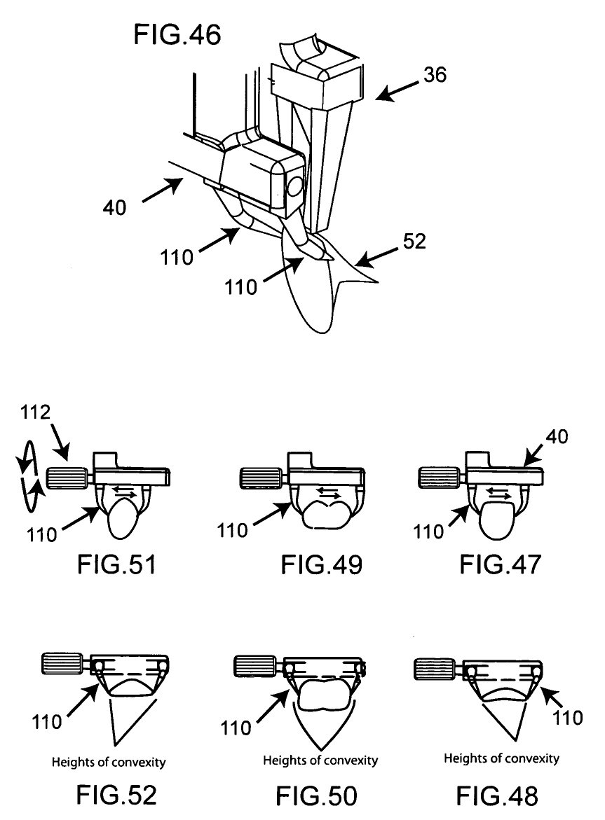

FIG. 46-52 show the position of the rotation arms 110 of the rotation register assembly 40 resting on the heights of convexity of various types of teeth. FIG. 46 shows the position of the rotation arms 110 resting on the heights of convexity of an incisor tooth, as just shown in FIG. 45. (In this figure, the vertical register assembly is in the position shown in FIG. 25.) Similarly, FIGS. 47 and 48 show front and bottom views, respectively, of the position of the rotation arms 110 resting on the heights of convexity of an incisor tooth. FIGS. 49 and 50 show front and bottom views, respectively, of the position of the rotation arms 110 resting on the heights of convexity of a molar tooth. And FIGS. 51 and 52 show front and bottom views, respectively, of the position of the rotation arms 110 resting on the heights of convexity of a canine tooth.

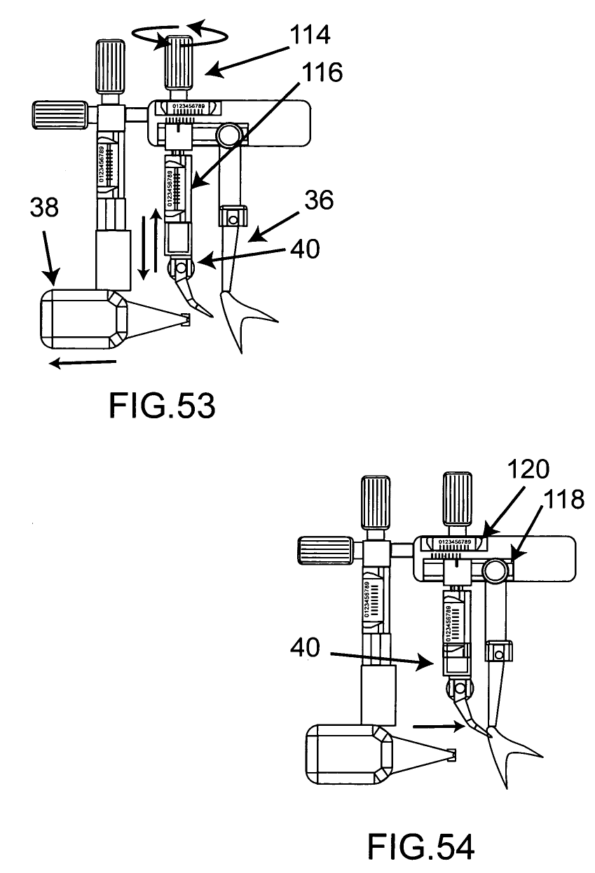

FIGS. 53 and 54 show further details of the rotation register assembly 40, which preferably includes a vertical control 114, a vertical scale 116, a horizontal control 118, and a horizontal scale 120 mounted on the frame 44 of the composite register assembly 34 (see FIG. 6). In a typical commercial embodiment, the vertical and horizontal controls 114 and 118 are provided by rack-and-pinion gear mechanisms, and the vertical and horizontal scales 116 and 120 register the vertical and horizontal values in millimeters. It will be understood that other conventional vertical and horizontal control mechanisms and scales may be provided.

FIG. 53 shows the vertical control 114 being operated to move the rotation arms 110 vertically into position at the heights of convexity of the tooth. And FIG. 54 shows the horizontal control 118 being operated to move the rotation arms 110 horizontally towards engagement with the heights of convexity of the tooth. The vertical and horizontal controls 114 and 118 provide greater flexibility and permit very precise positioning.

As described above, the vertical register assembly 36 and the torque register assembly 38 are each spring-loaded or otherwise clutched by, for example, the vertical sliding mechanism 68 (see FIGS. 17 and 18) and the spring members 102 (see FIGS. 39 and 40), respectively. And the rotation register assembly 40 rotates freely at the rotational coupling 106 (see FIG. 42). In this way, these three assemblies are free-floating so that they can be adjusted without necessarily having to lock and release any controls. In addition, the spring-loading of the vertical register assembly 36 and the torque register assembly 38 biases the vertical register arms 78 and the torque register head 84 toward engagement with the tooth being worked on so that as one of the register assemblies is adjusted the others tend to maintain their engagement. This is advantageous because changing any one relation will likely have the consequence of changing another relation. Therefore, after adjusting one relation, all others must be re-evaluated and re-adjusted if needed.

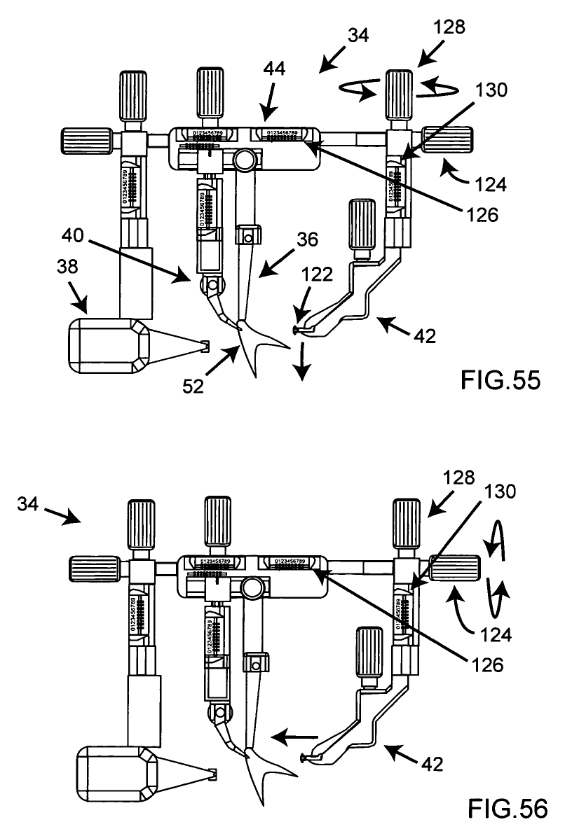

Having now registered the vertical, axial, torque, and rotation values for the tooth, FIGS. 55 and 56 show the use of the bracket holder assembly 42 to position the bracket 122 on the lingual surface of the tooth. The bracket holder assembly 42 preferably includes a horizontal control 124, a horizontal scale 126, a vertical control 128, and a vertical scale 130 mounted on the frame 44 of the composite register assembly 34 (see FIG. 6). In a typical commercial embodiment, the horizontal and vertical controls 124 and 128 are provided by rack-and-pinion gear mechanisms, and the horizontal and vertical scales 126 and 130 register the horizontal and vertical values in millimeters. It will be understood that other conventional horizontal and vertical control mechanisms and scales may be provided.

FIG. 55 shows the vertical control 124 being operated to move the bracket 122 vertically into position but horizontally offset from the lingual tooth surface. And FIG. 56 shows the horizontal control 128 being operated to move the bracket 122 horizontally into precise position relative to the lingual tooth surface.

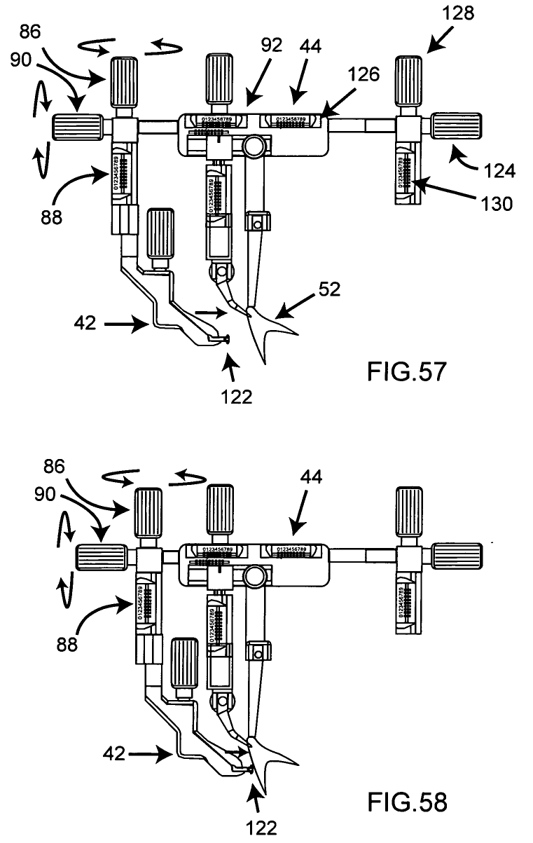

In order to position the brackets 122 on the facial surfaces of the teeth 52, FIGS. 57 and 58 show the bracket holder assembly 42 relocated to the position where the torque register assembly 38 was located. That is, the bracket holder assembly 42 is relocated from the horizontal and vertical controls 124 and 128 and scales 126 and 130 on the back side of the frame 44 of the composite register assembly 34 to the horizontal and vertical controls 90 and 86 and scales 92 and 88 on the front side of the frame 44 (see FIG. 8). As shown in FIGS. 57 and 58, the vertical control 86 is operated to move the bracket 122 vertically into position and the horizontal control 90 is operated to move the bracket 122 horizontally into precise position relative to the facial tooth surface. Because the brackets 122 are being positioned on the facial tooth surface instead of the lingual surface, the torque register assembly 38 (which registers the facial surface of the tooth because of the well documented consistency of its anatomy) is only needed in a prior step to set the proper torque angle.

FIGS. 59-61 show additional details of the bracket holder assembly 42, which includes a control 132 that operates a bracket receiver mechanism 134. In a typical commercial embodiment, the control 132 is provided by a rack-and-pinion or worm gear mechanism and the bracket receiver mechanism 134 is provided by grasping pinchers. In alternative embodiments, the bracket receiver mechanism 134 is provided by an opening that axially or laterally receives the bracket (or a bracket-holding clip) and holds it with a friction fit, a detent, or a spring-loaded catch pin, and the control 132 is provided by a spring-loaded mechanism that allows the operator to manually open the pinchers or other bracket receiver mechanism 134. It will be understood that other conventional receiver mechanisms and controls for them can be used.

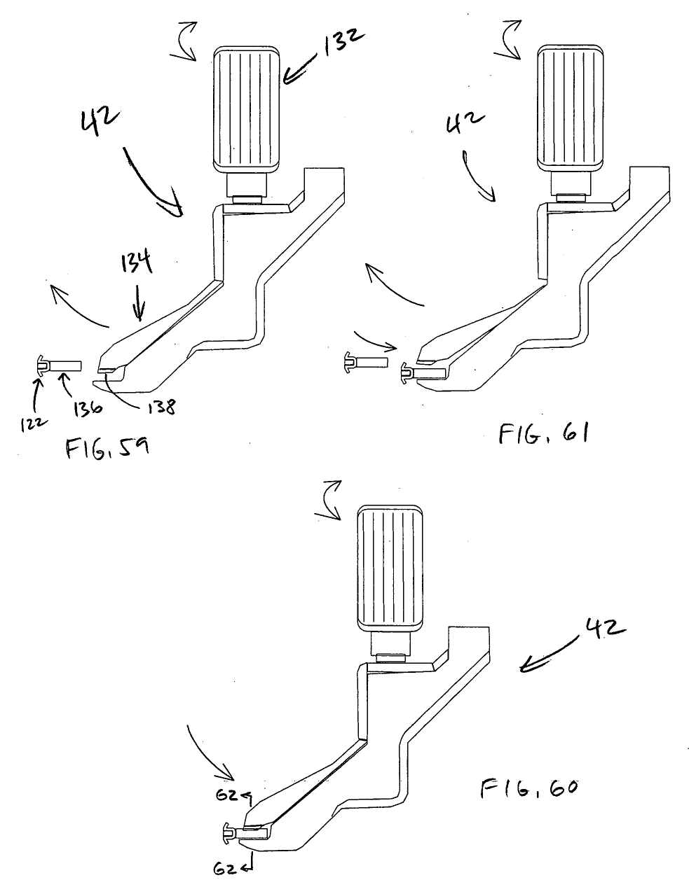

FIG. 56 shows the control 132 being operated to open the bracket receiver mechanism 134 to receive a clip 136 holding a bracket 122. FIG. 60 shows the shows the control 132 being operated to close the bracket receiver mechanism 134 to grasp the clip 136 holding the bracket 122. And FIG. 61 shows the control 132 being operated to reopen the bracket receiver mechanism 134 to release the clip 136 so that it can receive another one.

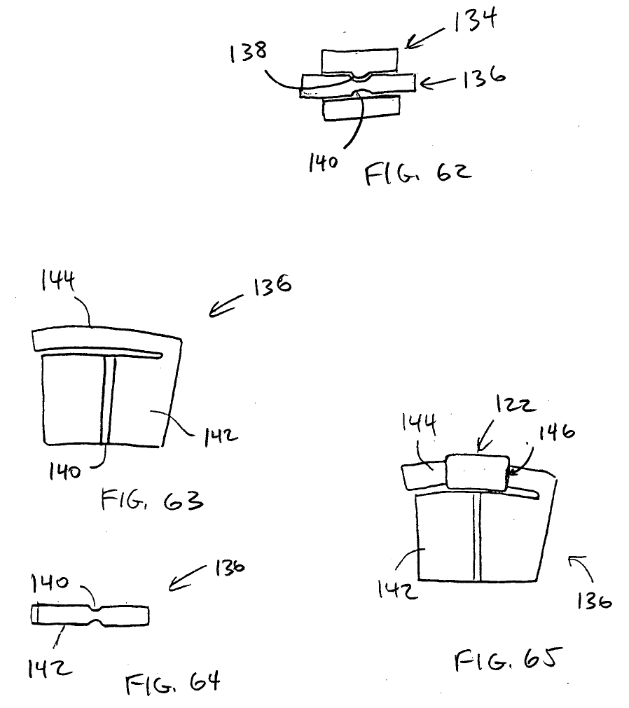

FIGS. 62-65 show additional details of the grasping clip 136. The clip 136 is used to hold the bracket 122 in position while it is being attached to the tooth 52. Preferably, the clip 136 has a finger 144 that it is received in an opening in the bracket 122 and a handle portion 142 for grasping. In addition, the bracket receiver mechanism 134 is preferably keyed for use with the handle 142, so that the clip 136 can be consistently aligned when grasping it with the bracket holder assembly 42. For example, the bracket receiver mechanism 134 may have ridges 138 that are received in grooves 140 on either side of the handle 142, or vice versa, so that the clip 136 can be flipped either side up and still aligned and centered in the bracket receiver mechanism (see FIGS. 62 and 59). Further details and description of the bracket grasping clip 136 are provided in U.S. patent application Ser. No. 10/______ , filed Dec. 31, 2003, entitled “Orthodontic Bracket and Method of Attaching Orthodontic Brackets to Teeth,” which is hereby incorporated by reference in its entirety. The device 10 and the bracket holder assembly 42 are intended primarily for use with clips 136 of this type, though they can be used to hold other clips or the brackets directly, if desired.

FIG. 66 shows a first exemplary bracket 122 for use with the clip 136 of FIG. 59 on molar teeth The bracket 122 has a body 148 with an opening 146 for receiving the arch-wire and bonding wings 150 for enhanced bonding strength. Preferably, the body 148 of the bracket 122 does not have a flat (or other shaped) base with a broad surface area for bonding directly to the tooth and fixing the position of the opening, as do conventional brackets.

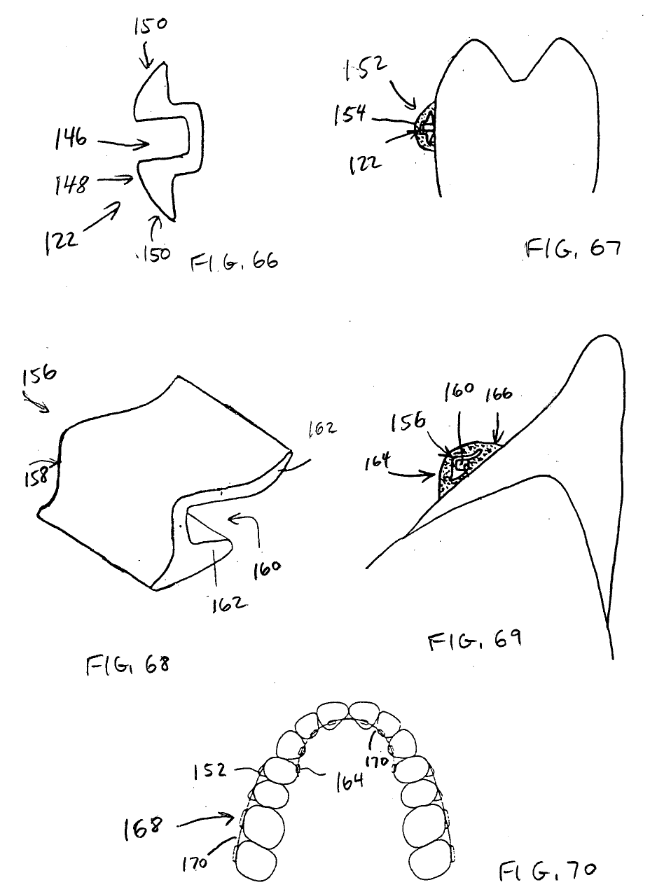

FIG. 67 shows a first exemplary attachment 152 made using the bracket 122 of FIG. 66, with the attachment formed on the facial surface of a pre-molar tooth. The attachment 152 includes a mass of adhesive 154 bonded to the tooth with the bracket 122 bonded to the adhesive mass.

FIG. 68 shows a second exemplary bracket 156 for use with the clip 136 of FIG. 59 on the lingual surface of anterior teeth. The bracket 156 has a body 158 with an opening 160 for receiving the arch-wire and bonding wings 162 for enhanced bonding strength. Similarly to the first exemplary bracket 122, the body 158 of the bracket 156 preferably does not have a flat (or other shaped) base with a broad surface area for bonding directly to the tooth and fixing the position of the opening, as do conventional brackets.

FIG. 69 shows a second exemplary attachment 164 made using the bracket 156 of FIG. 68, with the attachment formed on the lingual surface of an incisor tooth. The attachment 164 includes a mass of adhesive 166 bonded to the tooth with the bracket 156 bonded to the adhesive mass.

FIG. 70 shows an arch of teeth with an exemplary orthodontic appliance 168 including the attachments 156 of FIG. 69 on lingual surfaces of anterior teeth, two sets of the attachments 152 of FIG. 67 on facial surfaces of posterior teeth, and three arch-wires 170. In this way, the appliance 168 is sectionalized into two posterior teeth sections and one anterior teeth section. Preferably, the anterior teeth section overlaps with the posterior teeth sections, as shown. In this context, “overlapping” means that more than one of the appliance sections are present on a particular tooth, even if the sections each terminate shy of each other (so that a vertical line can not be drawn through them both).

Further details and description of the brackets, attachments, and appliances are provided in U.S. patent application Ser. No. 10/______ , filed Dec. 31, 2003, entitled “Orthodontic Bracket and Method of Attaching Orthodontic Brackets to Teeth.” The device 10 and the bracket holder assembly 42 are intended primarily for use with brackets of this type to form attachments and appliances of this type, though they can be used with other brackets to form other types of attachments and appliances.

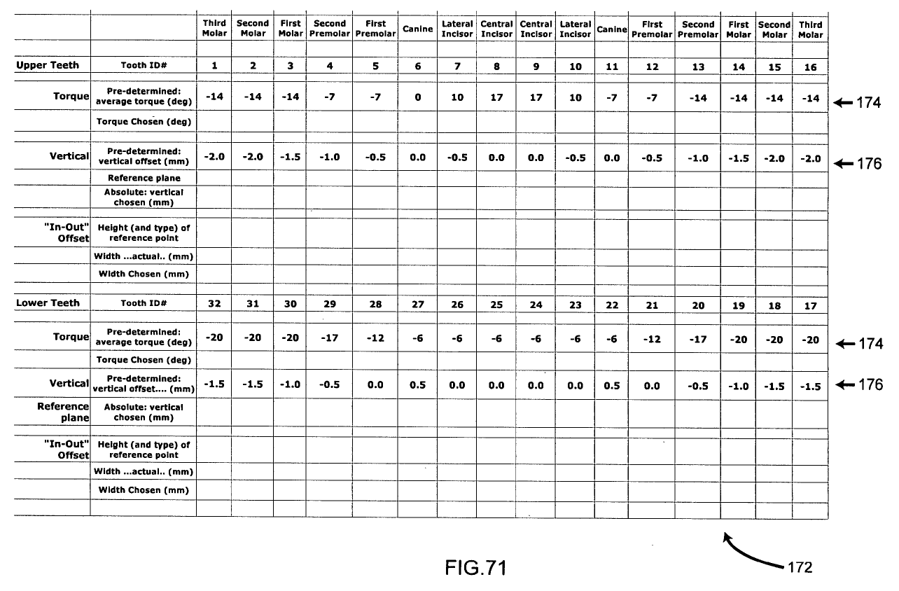

Having thus described the details and general operation of the device 10 and its various components, there will now be described an exemplary indirect method of positioning orthodontic brackets on teeth. The method will be described in conjunction with the positioning device and related structures described herein and with the table 172 shown in FIG. 71. But it should be understood that other positioning devices, register assemblies, clips, and brackets can be used to carry out the steps of this aspect of the invention.

Before proceeding with method, the details of the table 172 of FIG. 71 will be described. The table 172 includes predetermined vertical values 176 and predetermined torque values 174 for both the upper and lower arches of teeth. These values 176 and 174 are preferably based on averages for the general population because these values do tend to not vary widely. It will be understood, however, that other values may be selected for use based on the operator's experience and judgment.

Proceeding now with the method, it includes the step of selecting predetermined torque and vertical offset values. Preferably, these predetermined torque and vertical offset values 174 and 176 are drawn directly from the table 172, but they can be adjusted or differently selected as deemed appropriate by the doctor for each individual case. Any deviations, however, will be typically within fairly narrow parameters for any given tooth. Any such torque values that deviate from the averages in the table can be recorded by the operator in the “Torque chosen” row. For most cases, however, the recommended predetermined torque and vertical offset values 174 and 176 can be used.

The method further includes the step of providing one or more devices for registering tooth positions and positioning brackets, such as the device 10 described in detail herein. When using the device 10, it is first set to its “ready” position, which &ay vary depending on the particular task. To set the device 10 in its ready position, the adjustable joints should be positioned so as not to interfere. Thus, this step typically includes elevating the suspended portion 24 of the superstructure 14 and rotating it from over the base 12, backing out the bracket holder assembly 42, retracting the torque register assembly 38, retracting/elevating the rotation register assembly 40, and leveling the platform 18.

Then a teeth model 52 is secured in a fixed position. When using the device 10, the teeth model 52 is secured to the platform 18 as shown in FIGS. 9 and 10. For the operator's convenience, it is preferable to position the model teeth 52 on the platform with the anterior teeth facing the operator.

In addition, when using the device 10, the teeth model 52 can be leveled. This is done by adjusting the platform 18 as shown in FIGS. 11 and 12 until the teeth model is leveled. The platform 18 can be manually adjusted by visual inspection, or it can be adjusted by using the teeth model orienting assembly 46 shown in FIG. 7. To do this, the teeth model orienting assembly 46 is engaged in the frame 44 of the device 10 and the suspended portion 24 of the superstructure 14 is lowered. This is done by releasing the control 70 to permit the spring-loaded vertical sliding mechanism 68 to bias the plate 48 of the teeth model orienting assembly 46 downward onto the teeth model 52, which in turn forces the teeth model to a level position. Then the platform is locked in place by the control 60 to hold the level position, the superstructure suspended portion 24 is elevated, and the control 70 is relocked.

The method further includes the step of providing an orthodontic bracket suitable for positioning on the subject tooth. When using the device 10, the bracket is preferably provided by one of the brackets 122 or 156 or an equivalent, though conventional brackets could be used. More preferably, for each tooth, one of the brackets is loaded on one of the clips 136 or an equivalent, which is loaded on the bracket holder assembly 42.

The next step is determining the “absolute vertical height” value for each tooth. First the “reference plane” is selected for each segment and, based on the predetermined vertical offset values, the “absolute vertical height” for the relevant “reference plane” is determined. Each appliance segment is defined by a reference plane. The reference plane represents the desired final (post-treatment) arrangement of the bracket slots in a flat plane. In other words, the reference plane is defined by a series of vertical linear measurements (e.g., in millimeters) made from the incisal edge (anterior teeth), cusp tips (posterior teeth), or marginal ridge (posterior teeth) to the centerline of the bracket slot.

The operator of the device should select the vertical position of the reference plane considering a couple of factors. First, the attachments should not be too close to the gingiva or they will impinge on the gingival tissues. And second, the attachments should not be positioned too far toward the occlusal (incisal) edge of the tooth or they will interfere with the opposing teeth inside the mouth. Accordingly, the brackets and thus the reference plane should tend to be positioned toward the vertical mid-point of each tooth.

The operator determines by visual inspection which tooth or teeth will likely limit the vertical placement of the brackets, and determines by visual inspection of that likely limiting tooth an approximate reference plane based on the predetermined off-sets. Once an estimated reference plane is selected in this manner, then the bracket slot's absolute vertical height value can be determined. The bracket slot's absolute vertical height value reflects the adjustment for the offset value for that particular tooth from the predetermined vertical values. Thus, the “absolute vertical height” value for each tooth is the selected reference plane value minus the predetermined vertical offset value.

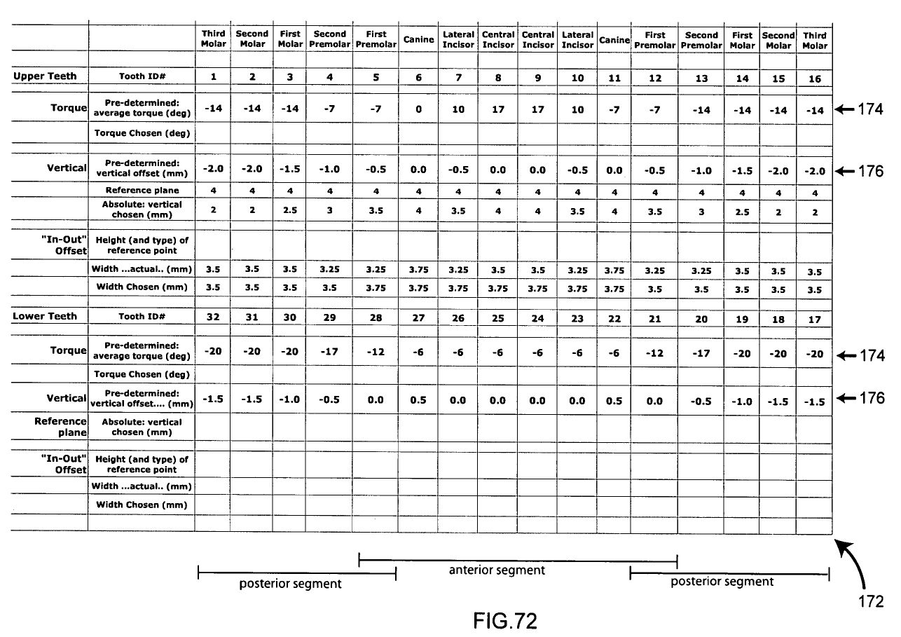

An as example, to form the three-segmented appliance 168 of FIG. 70, if the reference plane for all three segments for an upper arch of teeth is selected at 3 mm, then the absolute vertical height values are as follows: upper central incisor 3 mm (−0.0 mm), lateral incisor 2.5 m (−0.5 mm), canine 3 mm (−0.0 mm), first premolar 2.5 mm (−0.5 mm), second premolar 2.0 mm (−1.0 mm), etc. These values can then be recorded, for example, as shown in the table 172 of FIG. 72, as shown.

To confirm that the estimated reference plane that was selected will result in the brackets being well-positioned vertically, a “test run” can be done with the positioning device. The torque, rotation, axial, etc. positioning should be closely approximated for this “test run” but need not be precisely set (remember that all spatial relations must always be considered). Recommended vertical offset and torque values 176 and 174 are provided in the table 172.

In particular, the test run is conducted by, for each tooth in the segment, setting the torque register assembly to the predetermined torque value, setting the rotation register assembly to be approximately parallel to the reference plane (by eye is typically sufficient), and setting the vertical register assembly to the absolute vertical height value that was recorded. If the brackets end up being well-positioned vertically, then the estimated reference plane and absolute vertical height values can be used and the operator can proceed to the next step. If the result is that the brackets end up being too low or high, then the operator can re-estimate the reference plane higher or lower, respectively, and repeat the test run to confirm these re-estimates will work well.

Next in the method, the “usable” horizontal width value is determined for each tooth. This step preferably includes selecting a reference point for the segment, measuring the actual horizontal width of each tooth in the segment (the “In-Out” off-set), and then determining the “usable” value for the segment. The actual horizontal width is the horizontal measurement from the reference point, so the width value is not necessarily the physical width of the tooth at a given height. The actual horizontal width can be measured from one of several reference points, so long as all the bracket positions are coordinated to the same reference point. For example, the reference point may be the center of the facial surface at the determined vertical height, dual contact points on the facial surface at the determined vertical height, or dual contact points at the inter-proximal heights of convexity. Preferably, the type and height type of the reference points are then recorded, for example, in the table 172.

Then the actual horizontal width (the “in-out” off-set) is measured, for example by using the rotation register assembly of the device. In particular, with the vertical register assembly positioned at the determined absolute vertical height (and thus the axial position of the tooth registered), the torque register assembly positioned to register the predetermined torque, and the rotation register assembly positioned to register the rotation of the tooth, the reading on the horizontal scale for the rotation register assembly is a measurement of the actual tooth width/“in-out” offset. Preferably, the “in-out” off-set values are then recorded, for example, in the table 172 shown in FIG. 72.

Once the actual width/in-out offset values have been determined, then the usable horizontal value for each segment can be determined. Preferably, the attachments are to be positioned as close to the tooth surface as possible on all teeth, because a lower profile provides greater comfort to the patient. Therefore, the widest (thickest) tooth will be the one considered the “limiting factor.” All other brackets are then offset relative to the thickest width measure. In addition, it is preferable to allow a minimal amount of space between the brackets and the tooth surface to allow room for possible repositioning at a later time to perfect coordination. So the largest in-out offset value measured for each segment is the minimum usable value for that segment. Preferably, the width value actually used will be slightly greater than the recorded usable value. To continue the example started above for the absolute vertical values, the table 72 in FIG. 72 shows typical measured in-out offset values and, based on these, the useable width values for each segment.

Then the bracket positioning and fixation sequence of the method is performed on each tooth of a particular reference plane. At this point, all the needed torque, vertical, and in-out offset values are now recorded in the table 172. The operator may then proceed with final positioning and fixation of the brackets to form the attachments. Generally described, this step includes adjusting the free-floating vertical register assembly 36, torque register assembly 38, and rotation assembly 40, and then adjusting the bracket holder assembly 42 to precisely position the bracket. More particularly described, this step includes, using the recorded values for each tooth, horizontally centering the suspended portion 24 of the superstructure 14 (see FIGS. 15 and 16), lowering the superstructure suspended portion (see FIGS. 17 and 18) and, if needed, downwardly pivoting the composite register assembly 34 (see FIGS. 19 and 20) to engage the teeth with the vertical register assembly 36. The vertical register arms 78 are now set in a position defining a line that is coordinated with the occlusal end of the tooth, that is, parallel to a line or in a plane defined by the occlusal end of the tooth (see FIG. 25), thereby registering the axial position of the tooth, which in turn permits the bracket to be coordinated with the tooth's axial position and thus be oriented in the same axial position. This step further includes adjusting the torque register assembly 38 so that it registers the recorded torque values (see FIGS. 26-34) and adjusting the rotation assembly 40 so that it registers the recorded useable horizontal value (see FIGS. 42-54). The rotation register arms 110 are now set in a position defining a line that is coordinated with the tooth surface, that is, parallel to the line defining the ideal rotational position of the tooth (see FIGS. 44 and 45), thereby registering the rotational position of the tooth, which in turn permits the bracket to be coordinated with the tooth's rotational position and thus be oriented in the same rotational position.

Then, with the device 10 registering the recorded values, the next step is adjusting the bracket holder assembly 42 to precisely orient and position the bracket relative to the tooth surface (see FIGS. 55-58). In particular, the bracket holder assembly 42 is adjusted to orient the bracket with respect to three dimensions by positioning it at the predetermined torque angle value, the determined absolute vertical height value, and the useable horizontal value.

Because the bracket is registered to the tooth by the vertical register assembly, the torque register assembly, and the rotation register assembly, the bracket is automatically set in the precise axial and rotational position. With the bracket held in a suspended position horizontally offset from the model tooth surface and oriented so that its opening will be coordinated with the adjacent bracket openings to form a smooth and continuous arch-shaped wire pathway upon completion of the orthodontic treatment, it is then adhered in place using a conventional adhesive. And then the bracket is disengaged from the bracket holder assembly 42.

These steps are then repeated for each tooth/bracket in a segment or reference plane of the appliance. In the exemplary appliance 168 of FIG. 70, each set (upper or lower arch) of teeth has three different reference planes (two are coplanar) with two overlap points. Other arrangements can be implemented with as many or as few segments as desired. The anterior teeth reference plane spans from the left canine or first premolar to the right canine or first premolar. The right posterior reference plane spans from the right-most distal molar (second or third molar) to the canine or first premolar (overlap tooth). And the left posterior reference plane spans from the left-most distal molar (second or third molar) to the canine or first premolar (overlap tooth). The segments overlap at the end-teeth of the adjoining segments, with the end-teeth having two brackets, one on the facial side and one on the lingual side.

The registering and positioning method just described can be incorporated into the indirect attachment method described in U.S. patent application Ser. No. 10/______ , filed Dec. 31, 2003, entitled “Orthodontic Bracket and Method of Attaching Orthodontic Brackets to Teeth.” Of course, other conventional techniques for indirectly attaching orthodontic brackets to teeth can be used with the registering and positioning method described herein.

In view of the foregoing, it will be appreciated that the present invention provides a number of advantages over conventional bracket attachment techniques. Generally, the present invention provides methods and devices for accurately orientating and positioning orthodontic brackets on the lingual and/or facial surfaces of teeth. In particular, the bracket positioning device and method advantageously permit the operator to precisely register the orientation of mall-occluded teeth and, based on the values registered, precisely position the brackets with a high degree of flexibility and customization. In this way, the orthodontic treatment can be completed to reposition the patient's teeth more quickly and with less patient discomfort.

In addition, other advantages provided by the invention include the ability to precisely position orthodontic brackets on either the facial or lingual side of a tooth by referencing non-adjacent, non-contiguous anatomic tooth features, completely offset from and out of contact with the tooth surface, off-centered to the mesial or distal side without compromising integrity of position, and coordinated with other brackets to create ideal alignment of any teeth while maintaining relatively consistent curvature of all wire segments. Further advantages provided by the invention include the ability to precisely position edgewise orthodontic brackets so that anterior closed-face brackets can be used, non-adjustable brackets can be used, wire segments can be used that simulate a continuous arch-wire system, and bracket and slot orientations and spatial relations can be quantified in three dimensions of space by referencing non-adjacent, non-contiguous anatomic features on both facial and lingual aspects of teeth. And still other advantages include the ability to create fully customized bracket prescriptions for fixed orthodontia and custom-shaped fixed orthodontic attachments that match natural contours of teeth to maximally camouflage them, improve their appearance when on the facial side of teeth, and maximize their comfort regardless of position.

It is to be understood that this invention is not limited to the specific devices, methods, conditions, and/or parameters described and/or shown herein, and that the terminology used herein is for the purpose of describing particular embodiments by way of example only. Thus, the terminology is intended to be broadly construed and is not intended to be limiting of the claimed invention. In addition, as used in the specification including the appended claims, the singular forms “a,” “an,” and “the” include the plural, plural forms include the singular, and reference to a particular numerical value includes at least that particular value, unless the context clearly dictates otherwise. Furthermore, any methods described herein are not intended to be limited to the sequence of steps described but can be carried out in other sequences, unless expressly stated otherwise herein.

Moreover, while certain embodiments are described above with particularity, these should not be construed as limitations on the scope of the invention. It should be understood, therefore, that the foregoing relates only to exemplary embodiments of the present invention, and that numerous changes may be made therein without departing from the spirit and scope of the invention as defined by the following claims.

1. A device for positioning orthodontic brackets on a model of a set of teeth, comprising:
a vertical register assembly that is adjustable to register an axial position of each model tooth;
a rotation register assembly that is adjustable to register a rotational position of each model tooth;
a torque register assembly that is adjustable to register a torque position of each model tooth; and
a bracket holder assembly that is adapted to hold a bracket in a fixed relationship to the registered axial, rotational, and torque positions of each model tooth, and that is adjustable to orient the bracket in three dimensions relative to each model tooth.

2. The positioning device of claim 1, wherein the vertical register assembly includes two vertical register arms and a control operably coupled to the vertical register arms that is adapted to horizontally adjust a spaced apart width of the arms.

3. The positioning device of claim 1, wherein the rotation register assembly includes two rotation register arms and a control operably coupled to the rotation register arms that is adapted to horizontally adjust a spaced apart width of the arms.

4. The positioning device of claim 1, wherein the torque register assembly includes body, a scale, and a register head that is rotationally coupled to the body and operably coupled to the scale.

5. The positioning device of claim 4, wherein the register head is biased towards vertical so that the register head maintains engagement with the tooth as torque register assembly is adjusted.

6. The positioning device of claim 4, wherein the register head includes a plate and a perpendicular member that cooperate to form a cross-shaped engagement surface for registration in two dimensions.

7. The positioning device of claim 1, wherein the vertical register assembly, the rotation register assembly, and the torque register assembly are free-floating and biased towards engagement with the model teeth.

8. The positioning device of claim 1, further comprising a platform adapted for securely mounting the teeth model.

9. The positioning device of claim 8, further comprising:
a base; and
a superstructure mounted to the base, the superstructure including the platform, the vertical register assembly, the rotation register assembly, the torque register assembly, and the bracket holder assembly.

10. The positioning device of claim 9, wherein the superstructure further comprises a turntable that is mounted to the base and adapted for rotation in a horizontal plane, wherein the platform is mounted to the turntable and adapted for adjustment in a three dimensions.

11. The positioning device of claim 1, further comprising a frame having at least two attachments adapted for interchangeably attaching the torque register assembly and the bracket holder assembly.

12. The positioning device of claim 1, further comprising a model teeth orienting assembly having an engagement member that levels the model teeth upon engagement therewith.

13. The positioning device of claim 12, further comprising a frame having at least two attachments adapted for interchangeably attaching the torque register assembly, the bracket holder assembly, and the model teeth orienting assembly.

14. A device for positioning orthodontic brackets on a model of a set of teeth, comprising:
a vertical register assembly that is adjustable to register an axial position of each model tooth; and
a bracket holder assembly that is adapted to hold a bracket in a fixed relationship to the registered axial position of each model tooth and adjustable to orient the bracket in three dimensions relative to each model tooth.

15. The positioning device of claim 14, wherein the vertical register assembly includes two vertical register arms and a control operably coupled to the vertical register arms that is adapted to horizontally adjust a spaced apart width of the arms.

16. The positioning device of claim 14, further comprising a rotation register assembly that is adjustable to register a rotational position of each model tooth and a torque register assembly that is adjustable to register a torque position of each model tooth.

17. The positioning device of claim 14, wherein the vertical register assembly is free-floating and biased towards engagement with the model teeth.

18. A device for positioning orthodontic brackets on a model of a set of teeth, comprising:
a rotation register assembly that is adjustable to register a rotational position of each model tooth; and
a bracket holder assembly that is adapted to hold a bracket in a fixed relationship to the registered rotational position of each model tooth and adjustable to orient the bracket in three dimensions relative to each model tooth.

19. The positioning device of claim 18, wherein the rotation register assembly includes two rotation register arms and a control operably coupled to the rotation register arms that is adapted to horizontally adjust a spaced apart width of the arms.

20. The positioning device of claim 18, further comprising a vertical register assembly that is adjustable to register an axial position of each model tooth and a torque register assembly that is adjustable to register a torque position of each model tooth.

21. The positioning device of claim 18, wherein the rotation register assembly is free-floating and biased towards engagement with the model teeth.

22. A device for positioning orthodontic brackets on a model of a set of teeth, comprising:
a torque register assembly that is adjustable to register a torque position of each model tooth; and
a bracket holder assembly that is adapted to hold a bracket in a fixed relationship to the registered torque position of each model tooth and adjustable to orient the bracket in three dimensions relative to each model tooth.

23. The positioning device of claim 22, wherein the torque register assembly includes body, a scale, and a register head that is rotationally coupled to the body and operably coupled to the scale.

24. The positioning device of claim 23, wherein the register head is biased towards vertical so that the register head maintains engagement with the tooth as torque register assembly is adjusted.

25. The positioning device of claim 23, wherein the register head includes a plate and a perpendicular member that cooperate to form a cross-shaped engagement surface for registration in two dimensions.

26. The positioning device of claim 22, further comprising a rotation register assembly that is adjustable to register a rotational position of each model tooth and a vertical register assembly that is adjustable to register an axial position of each model tooth.

27. The positioning device of claim 22, wherein the torque register assembly is free-floating and biased towards engagement with the model teeth.

28. A device for positioning orthodontic brackets on a model of a set of teeth, comprising:
at least one register assembly that is adjustable to register a position of each model tooth; and
a bracket holder assembly that is adapted to hold a bracket in a fixed relationship to the registered position of each model tooth and adjustable to orient the bracket in three dimensions relative to each model tooth.

29. The positioning device of claim 28, wherein the register assembly includes a vertical register assembly that is adjustable to register an axial position of each model tooth, a rotational register assembly that is adjustable to register a rotational position of each model tooth, a torque register assembly that is adjustable to register a torque position of each model tooth, or a combination thereof.

30. The positioning device of claim 28, wherein the register assembly is free-floating and biased towards engagement with the model teeth.

31. The positioning device of claim 28, wherein the bracket holder assembly includes a bracket receiver mechanism that is adapted to directly or indirectly hold the bracket.

32. The positioning device of claim 31, wherein the bracket holder assembly further includes a control that is operable for manipulating the bracket receiver mechanism to engage and release the bracket.

33. The positioning device of claim 31, wherein the bracket receiver mechanism is adapted to hold a clip that holds the bracket.

34. The positioning device of claim 33, wherein the bracket receiver mechanism is keyed for alignment with a matingly keyed portion of the clip.

35. A method of positioning orthodontic brackets on a model of a set of teeth, comprising:
determining a torque value for each bracket;
determining an absolute vertical height value for each bracket;
determining a useable horizontal value for each bracket;
registering an axial position of each tooth;
registering a torque position of each tooth;
registering a rotational position of each tooth;
positioning the bracket at the determined torque value with reference to the registered torque position;
positioning the bracket at the determined absolute vertical height value with reference to the registered axial position; and
positioning the bracket at the determined useable horizontal value with reference to the registered rotational position.

36. The method of claim 35, wherein the step of determining a torque value for each bracket comprises selecting predetermined torque values from a table including average torque values for a population.

37. The method of claim 35, wherein the step of determining an absolute vertical height value for each bracket comprises selecting a vertical offset value for each tooth, estimating a value representing a horizontal reference plane for a segment of the teeth, and determining the difference between the estimated horizontal reference plane value and the vertical offset value for each tooth.

38. The method of claim 37, wherein the step of selecting a vertical offset value for each tooth comprises selecting predetermined torque values from a table including average vertical offset values for a population.

39. The method of claim 37, further comprising the step of conducting a test run to determine whether, based on the absolute vertical height value for each bracket, each bracket in a segment of the brackets is vertically positioned in an acceptable position, and if not then further comprising the step of re-estimating the horizontal reference plane value and repeating the test run.

40. The method of claim 35, wherein the step of determining a useable horizontal value for each bracket comprises selecting a reference point for a segment of the teeth, measuring the actual horizontal width of each tooth in the segment, determining the difference between the reference point and the actual horizontal width of each tooth, and adopting the difference as the usable horizontal value for the segment.

41. The method of claim 40, wherein the step of selecting a reference point comprises selecting a center of a facial surface of each tooth at a vertical height, selecting two contact points on a facial surface of each tooth at vertical height, selecting two contact points at inter-proximal heights of convexity of each tooth, or a combination thereof.

42. The method of claim 35, wherein the step of registering an axial position of each tooth comprises moving a vertical register assembly into engagement with the tooth.

42. The method of claim 35, wherein the step of registering a torque position of each tooth comprises moving a torque register assembly into engagement with the tooth.

43. The method of claim 35, wherein the step of registering a rotational position of each tooth comprises moving a rotation register assembly into engagement with the tooth.

44. The method of claim 35, wherein the steps of positioning the bracket comprise adjusting a vertical control and a horizontal control of a bracket holder assembly.

45. The method of claim 35, further comprising the step of securing the teeth model in a fixed position on a platform.

46. The method of claim 45, further comprising the step of leveling the teeth model and the platform.

47. The method of claim 45, further comprising the step of loading one of the brackets onto a clip and loading the clip onto a bracket holder assembly.

48. The method of claim 45, further comprising the step of moving the bracket holder assembly to orient the bracket in three dimensions relative to the tooth so that an opening of the bracket be coordinated with adjacent bracket openings to form a arch-shaped wire pathway upon completion of the orthodontic treatment.

49. The method of claim 48, wherein the steps of positioning the bracket comprise holding the bracket in a suspended position horizontally offset from the model tooth, and further comprising the step of adhering the bracket in the suspended position.

50. The method of claim 35, further comprising repeating the steps of claim 35 for each tooth in a segment of the teeth.

51. The method of claim 50, further comprising repeating the steps of claim 35 for a plurality of teeth segments, wherein the step of positioning the bracket comprises, for at least one of the tooth segments, positioning the corresponding brackets on lingual surfaces of the corresponding teeth and, for at least one other of the tooth segments, positioning the corresponding brackets on facial surfaces of the corresponding teeth.

52. The method of claim 51, wherein the step of positioning the brackets comprises positioning at least two bracket openings on a single tooth in an overlapping arrangement.
